(19) United States
(12) Patent Application Publication
(10) Pub. No.: US 2025/0380273 A1
(43) Pub. Date: Dec. 11, 2025

(54) METHOD AND APPARATUS FOR CONTROLLING OF ON-OFF SIGNALING OF NETWORK-CONTROLLED REPEATER FOR WIRELESS COMMUNICATION SYSTEMS

(71) Applicant: SAMSUNG ELECTRONICS CO., LTD., Suwon-si, Gyeonggi-do (KR)

(72) Inventors: Kyunggyu LEE, Suwon-si (KR); Yeongeun LIM, Suwon-si (KR); Hyoungju JI, Suwon-si (KR); Kyungjun CHOI, Suwon-si (KR)

(21) Appl. No.: 18/878,441

(22) PCT Filed: Jun. 20, 2023
(86) PCT No.: PCT/KR2023/008544

§ 371 Date: Dec. 23, 2024

(30) Foreign Application Priority Data
Jun. 24, 2022 (KR) 10-2022-0077639

(51) Int. Cl. H04W 72/231; H04L 1/1812; H04W 72/0446; H04W 88/04

(52) U.S. Cl. CPC H04W 72/231; H04L 1/1812; H04W 72/0446; H04W 88/04

(57) ABSTRACT

The present disclosure relates to a 5G or 6G communication system for supporting higher data transmission rates. A method performed by a network-controlled repeater (NCR) in a communication system according to an embodiment disclosed herein may comprise: receiving higher layer signaling including configuration information associated with the switching of the on-off state of the NCR; receiving control information including instruction information associated with the switching of the on-off state; and performing the switching of the on-off state on the basis of the configuration information and the control information.

### TECHNICAL FIELD

The disclosure relates generally to a wireless communication system and, more particularly, to a method and device for configuring on/off control of a network controlled repeater in a wireless communication system.

### BACKGROUND ART

Fifth generation (5G) mobile communication technology defines a wide frequency band to enable fast transmission speed and new services, and can be implemented not only in a sub-6 GHz frequency band (“sub 6 GHz”) such as 3.5 GHz but also in an ultra-high frequency band (“above 6 GHz”) called mmWave such as 28 GHz or 39 GHz. In addition, 6G mobile communication technology called “beyond 5G system” is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

In the early days of 5G mobile communication technology, to meet service support and performance requirements for enhanced mobile broadband (eMBB), ultra-reliable and low-latency communication (URLLC), and massive machine-type communications (mMTC), standardization has been carried out regarding beamforming for mitigating the pathloss of radio waves and increasing the propagation distance thereof in the mmWave band, massive MIMO, support of various numerology for efficient use of ultra-high frequency resources (e.g., operating multiple subcarrier spacings), dynamic operations on slot formats, initial access schemes to support multi-beam transmission and broadband, definition and operation of bandwidth parts (BWP), new channel coding schemes such as low density parity check (LDPC) codes for large-capacity data transmission and polar codes for reliable transmission of control information, L2 pre-processing, and network slicing for providing a dedicated network specialized for a specific service. Currently, discussions are underway to improve 5G mobile communication technology and enhance performance thereof in consideration of the services that the 5G mobile communication technology has initially intended to support, and physical layer standardization is in progress for technologies such as V2X (Vehicle-to-Everything) that aims to help a self-driving vehicle to make driving decisions based on its own location and status information transmitted by vehicles and to increase user convenience, new radio unlicensed (NR-U) for the purpose of system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as intelligent factories (industrial Internet of things, IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its location.

When such a 5G mobile communication system is commercialized, connected devices whose number is explosively increasing will be connected to the communication networks; accordingly, it is expected that enhancement in function and performance of the 5G mobile communication system and the integrated operation of the connected devices will be required. To this end, new research will be conducted regarding 5G performance improvement and complexity reduction, AI service support, metaverse service support, and drone communication by utilizing extended reality (XR) for efficiently supporting augmented reality (AR), virtual reality (VR), and mixed reality (MR), artificial intelligence (AI), and machine learning (ML).

Further, such advancement of 5G mobile communication systems will be the basis for the development of technologies such as new waveforms for ensuring coverage in the terahertz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes artificial intelligence (AI) from the design stage and internalizes end-to-end AI support functions to realize system optimization, and next-generation distributed computing that realizes services whose complexity exceeds the limit of terminal computing capabilities by utilizing ultra-high-performance communication and computing resources.

### DISCLOSURE OF INVENTION

### Technical Problem

Various embodiments of the disclosure provide a method for a base station to perform an on/off operation of the repeater through control signaling in a wireless communication system.

The technical objectives to be achieved in various embodiments of the disclosure are not limited to those mentioned above, and other technical objectives not mentioned may be considered by a person having ordinary skill in the art from various embodiments of the disclosure described below.

### Solution to Problem

According to an embodiment, a method performed by a network-controlled repeater (NCR) in a communication system may be provided.

According to an embodiment, the method may include receiving higher layer signaling including configuration information related to on-off state switching of the NCR.

According to an embodiment, the method may include receiving control information including indication information related to on-off state switching. According to an embodiment, the method may include performing on-off state switching based on the configuration information and the control information. According to an embodiment, in case that the configuration information includes a list of plural frequency resources, the control information may include first indication information indicating on-off states of the plural frequency resources, and whether to switch the on-off state of each frequency resource may be identified based on the first indication information.

According to an embodiment, the first indication information may be information indicating the on-off states of the plural frequency resources as a codepoint.

According to an embodiment, the method may further include transmitting capability information of the NCR.

According to an embodiment, in case that the capability information includes information indicating that the NCR has a capability of independently controlling on-off state switching for individual frequency resources, it may be possible for the configuration information to include a list of the plural frequency resources.

According to an embodiment, in case that the configuration information includes a list of plural panels, the control information may include second indication information indicating on-off states of the plural panels, and whether to switch the on-off state of each panel may be identified based on the second indication information.

According to an embodiment, the second indication information may be information indicating the on-off states of the plural panels as a codepoint. According to an embodiment, in case that the control information includes both the first indication information and the second indication information and the first indication information and the second indication information are represented by a single information field of the control information, the first indication information may correspond to the most significant bit (MSB) of the information field and the second indication information may correspond to the least significant bit (LSB) of the information field.

According to an embodiment, in case that the configuration information includes offset information, the point in time at which on-off state switching is performed may be identified based on the point in time at which the control information is received and the offset information.

According to an embodiment, in case that the offset information is slot-level offset information, on-off state switching may be performed at the first symbol of the slot to which the slot offset indicated by the offset information is applied with respect to the slot in which the control information is received.

According to an embodiment, in case that the offset information is symbol-level offset information, on-off state switching may be performed at a symbol following the symbol to which the symbol offset indicated by the offset information is applied with respect to the symbol at which the control information is received.

According to an embodiment, in case that the configuration information includes a list of plural time resources related to on-off state switching, the control information may include third indication information indicating a time resource among the plural time resources, and on-off state switching may be performed based on the third indication information.

According to an embodiment, a network-controlled repeater (NCR) in a communication system may be provided.

According to an embodiment, the NCR may include: a transceiver; and a processor connected to the transceiver.

According to an embodiment, the processor may be configured to receive higher layer signaling including configuration information related to on-off state switching of the NCR.

According to an embodiment, the processor may be configured to receive control information including indication information related to on-off state switching. According to an embodiment, the processor may be configured to perform on-off state switching based on the configuration information and the control information. According to an embodiment, in case that the configuration information includes a list of plural frequency resources, the control information may include first indication information indicating on-off states of the plural frequency resources, and whether to switch the on-off state of each frequency resource may be identified based on the first indication information.

According to an embodiment, a method performed by a base station in a communication system may be provided.

According to an embodiment, the method may include transmitting higher layer signaling including configuration information related to on-off state switching of a network-controlled repeater (NCR).

According to an embodiment, the method may include transmitting control information including indication information related to on-off state switching. According to an embodiment, in case that the configuration information includes a list of plural frequency resources, the control information may include first indication information indicating on-off states of the plural frequency resources. According to an embodiment, a base station in a communication system may be provided.

According to an embodiment, the base station may include: a transceiver; and a processor connected to the transceiver.

According to an embodiment, the processor may be configured to transmit higher layer signaling including configuration information related to on-off state switching of a network-controlled repeater (NCR).

According to an embodiment, the processor may be configured to transmit control information including indication information related to on-off state switching. According to an embodiment, in case that the configuration information includes a list of plural frequency resources, the control information may include first indication information indicating on-off states of the plural frequency resources. The various embodiments of the disclosure described above are only some of the preferred embodiments of the disclosure, and other various embodiments reflecting the technical features of the various embodiments of the disclosure may be derived and understood by a person having ordinary skill in the art on the basis of the detailed descriptions to be described below.

### Advantageous Effects of Invention

According to the disclosure, if the repeater can perform on/off operations under the control of the base station in a wireless communication system, the effects of reducing interference with the system and reducing power consumption can be expected.

The effects that can be obtained from various embodiments of the disclosure are not limited to those mentioned above, and other effects that are not mentioned can be clearly derived and understood by a person having ordinary skill in the art on the basis of the detailed descriptions below.

### BRIEF DESCRIPTION OF DRAWINGS

FIG. 1 a diagram illustrating a time-frequency domain transmission structure of a wireless communication system such as LTE (Long Term Evolution) or E-UTRA (Evolved Universal Terrestrial Radio Access), LTE-A (LTE-Advanced), NR, or a similar system according to an embodiment of the disclosure.

FIG. 2 is a diagram illustrating a structure for a frame, subframe, and slot in 5G (5^{th} generation) according to an embodiment of the disclosure.

FIG. 3 illustrates an example of bandwidth parts (BWPs) configured in a wireless communication system according to an embodiment of the disclosure.

FIG. 4 is a diagram illustrating the structure of a downlink control channel in a wireless communication system according to an embodiment of the disclosure.

FIG. 5 is a diagram illustrating the structure of a downlink control channel in a wireless communication system according to an embodiment of the disclosure.

FIG. 6 is a diagram illustrating an example of time domain resource allocation for the PDSCH in a wireless communication system according to an embodiment of the disclosure.

FIG. 7 is a diagram illustrating an example of time domain resource allocation for the PDSCH (physical downlink shared channel) in a wireless communication system according to an embodiment of the disclosure.

FIG. 8 is a diagram illustrating a method for configuring a semi-static HARQ-ACK codebook in the NR system.

FIG. 9 is a diagram illustrating a method for configuring a dynamic HARQ-ACK codebook in the NR system.

FIG. 10 is a diagram illustrating a method for configuring HARQ-ACK codebook retransmission in the NR system.

FIG. 11 is a diagram illustrating an example of uplink/downlink configuration (UL/DL configuration) in the 5G system, where three stages of uplink/downlink configuration of symbols/slots are illustrated.

FIG. 12 illustrates an example of transmission and reception associated with an NCR when the NCR relays between a base station and a UE according to an embodiment of the disclosure.

FIG. 13 illustrates an example of uplink transmission along an RF chain when an NCR relays between a base station and a UE according to an embodiment of the disclosure.

FIG. 14 illustrates an example of dynamic on-off signaling for an NCR according to an embodiment of the disclosure.

FIG. 15 illustrates an example of amplifying and forwarding the SSB by the NCR according to an embodiment of the disclosure.

FIG. 16 illustrates an example of semi-static on-off signaling for the NCR according to an embodiment of the disclosure.

FIG. 17 is a flowchart illustrating an example of NCR operation according to an embodiment of the disclosure.

FIG. 18 is a diagram illustrating the structure of a UE in a wireless communication system according to an embodiment of the disclosure.

FIG. 19 is a diagram illustrating the structure of a base station in a wireless communication system according to an embodiment of the disclosure.

### MODE FOR THE INVENTION

Hereinafter, embodiments of the disclosure will be described in detail with reference to the accompanying drawings.

In the following description of embodiments, descriptions of technical details well known in the art and not directly related to the disclosure may be omitted. This is to more clearly convey the subject matter of the disclosure without obscurities by omitting unnecessary descriptions.

Likewise, in the drawings, some elements are exaggerated, omitted, or only outlined in brief. Also, the size of each element does not necessarily reflect the actual size. The same or similar reference symbols are used throughout the drawings to refer to the same or like parts.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims. The same reference symbols are used throughout the description to refer to the same parts.

Meanwhile, it will be appreciated that blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a certain way, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for carrying out functions described in blocks of the flowchart. As the computer program instructions may be loaded on a computer or a programmable data processing equipment, when the computer program instructions are executed as processes having a series of operations on a computer or a programmable data processing equipment, they may provide steps for executing functions described in blocks of the flowchart.

Further, each block of a flowchart may correspond to a module, a segment or a code containing one or more executable instructions for executing one or more logical functions, or to a part thereof. It should also be noted that functions described by blocks may be executed in an order different from the listed order in some alternative cases. For example, two blocks listed in sequence may be executed substantially at the same time or executed in reverse order according to the corresponding functionality.

Here, the word “unit”, “module”, or the like used in the embodiments may refer to a software component or a hardware component such as an FPGA (field programmable gate array) or ASIC (application specific integrated circuit) capable of carrying out a function or an operation. However, “unit” or the like is not limited to software or hardware. A unit or the like may be configured so as to reside in an addressable storage medium or to drive one or more processors. Hence, according to some embodiments, units or the like may refer to components such as software components, object-oriented software components, class components or task components, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose larger components and units. Further, components and units may be implemented to drive one or more processors in a device or a secure multimedia card. Additionally, according to some embodiments, a component or unit may include one or more processors.

Hereinafter, the operating principle of the disclosure will be described in detail with reference to the attached drawings. In the following description of the disclosure, a detailed description of a related well-known function or configuration may be omitted if it would unnecessarily obscure the gist of the disclosure. Additionally, those terms described below are terms defined in consideration of the functions in this disclosure, and may vary depending on the intention or custom of the user or operator. Therefore, their meanings should be determined based on the contents throughout this specification. In the following description, the base station is a main agent that allocates resources to terminals, and may be at least one of, but not limited to, gNode B, eNode B, Node B, base station (BS), wireless access unit, base station controller, or node on the network. The terminal may be, but not limited to, a user equipment (UE), a mobile station (MS), a cellular phone, a smartphone, a computer, or a multimedia system capable of performing a communication function. Of course, it is not limited to the above examples. Hereinafter, the disclosure describes a technology for a UE to receive broadcast information from a base station in a wireless communication system. The disclosure relates to a communication technique and system thereof that combine a 5^{th} generation (5G) communication system supporting a higher data rate after a 4^{th} generation (4G) communication system with Internet of Things (IoT) technology. The disclosure can be applied to intelligent services (e.g., smart home, smart building, smart city, smart or connected car, healthcare, digital education, retail, security and safety related services) based on 5G communication technology and IoT related technology.

In the following description, terms With reference to broadcast information, terms With reference to control information, terms related to communication coverage, terms With reference to state changes (e.g., events), terms With reference to network entities, terms With reference to messages, terms With reference to components of devices, are examples taken for convenience of explanation. Hence, the disclosure is not limited to those terms described below, and other terms having equivalent technical meanings may be utilized.

For the convenience of the following explanation, some terms and names defined in the 3GPP LTE (3rd generation partnership project long term evolution) standard may be used. However, the disclosure is not limited by the above terms and names, and can be equally applied to systems complying with other standards.

Wireless communication systems are evolving from early systems that provided voice-oriented services only to broadband wireless communication systems that provide high-speed and high-quality packet data services, such as systems based on communication standards including 3GPP high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and IEEE 802.16e.

As a representative example of the broadband wireless communication system, the LTE system employs orthogonal frequency division multiplexing (OFDM) in the downlink (DL) and single carrier frequency division multiple access (SC-FDMA) in the uplink (UL). The uplink refers to a radio link through which a terminal (user equipment (UE) or mobile station (MS)) sends data or a control signal to a base station (BS or eNode B), and the downlink refers to a radio link through which a base station sends data or a control signal to a terminal. In such a multiple access scheme, time-frequency resources used to carry user data or control information are allocated so as not to overlap each other (i.e., maintain orthogonality) to thereby identify the data or control information of a specific user.

As a post-LTE communication system, namely, the 5G communication system must be able to freely reflect various requirements of users and service providers and need to support services satisfying various requirements. Services considered for the 5G communication system include enhanced mobile broadband (eMBB), massive machine type communication (mMTC), and ultra-reliable and low-latency communication (URLLC).

According to some embodiments, eMBB aims to provide a data transmission rate that is more improved in comparison to the data transmission rate supported by existing LTE, LTE-A, or LTE-Pro. For example, in the 5G communication system, eMBB must be able to provide a peak data rate of 20 Gbps in the downlink and a peak data rate of 10 Gbps in the uplink from the viewpoint of one base station. At the same time, eMBB has to provide an increased user perceived data rate for the terminal. To meet such requirements, it may be required to improve the transmission and reception technology including more advanced multi-antenna or multi-input multi-output (MIMO) technology. In addition, it is possible to satisfy the data transmission rate required by the 5G communication system by using a frequency bandwidth wider than 20 MHz in a frequency band of 3 to 6 GHz or 6 GHz or higher instead of a frequency band of 2 GHz currently used by LTE.

At the same time, in the 5G communication system, mMTC is considered to support application services such as the Internet of Things (IoT). For efficient support of IoT services, mMTC is required to support access of a massive number of terminals in a cell, extend the coverage for the terminal, lengthen the battery time, and reduce the cost of the terminal. The Internet of Things must be able to support a massive number of terminals (e.g., 1,000,000 terminals/km²) in a cell to provide a communication service to sensors and components attached to various devices. In addition, since a terminal supporting mMTC is highly likely to be located in a shadow area not covered by a cell, such as the basement of a building, due to the nature of the service, it may require wider coverage compared to other services provided by the 5G communication system. A terminal supporting mMTC should be configured as a low-cost terminal, and since it is difficult to frequently replace the battery of a terminal, a very long battery life time may be required. Finally, URLLC, as cellular-based mission-critical wireless communication for a specific purpose, is a service usable for remote control of robots or machinery, industrial automation, unmanned aerial vehicles, remote health care, and emergency alert. Hence, URLLC should provide ultra-reliable and low-latency communication. For example, a URLLC service may have to support both an air interface latency of less than 0.5 ms and a packet error rate of 10-5 or less as a requirement. Hence, for a service supporting URLLC, the 5G system must provide a transmission time interval (TTI) shorter than that of other services, and at the same time, a design requirement for allocating a wide resource in a frequency band may be required. However, mMTC, URLLC and eMBB described above are only examples of different service types, and the service types to which the disclosure applies are not limited to the above-mentioned examples.

The services considered in the 5G communication system described above should be provided by being integrated with each other based on a single framework. That is, for efficient resource management and control, it is desirable for individual services to be controlled and transmitted as an integrated system rather than operated independently.

Further, embodiments of the disclosure will be described by using LTE, LTE-A, LTE Pro, or NR systems as an example, but the embodiments of the disclosure may be applied to other communication systems having similar technical backgrounds or channel configurations. Also, it should be understood by those skilled in the art that the embodiments of the disclosure can be applied to other communication systems without significant modifications departing from the scope of the disclosure.

### <5G System Frame Structure>

Next, the frame structure of the 5G system will be described in more detail with reference to the drawings.

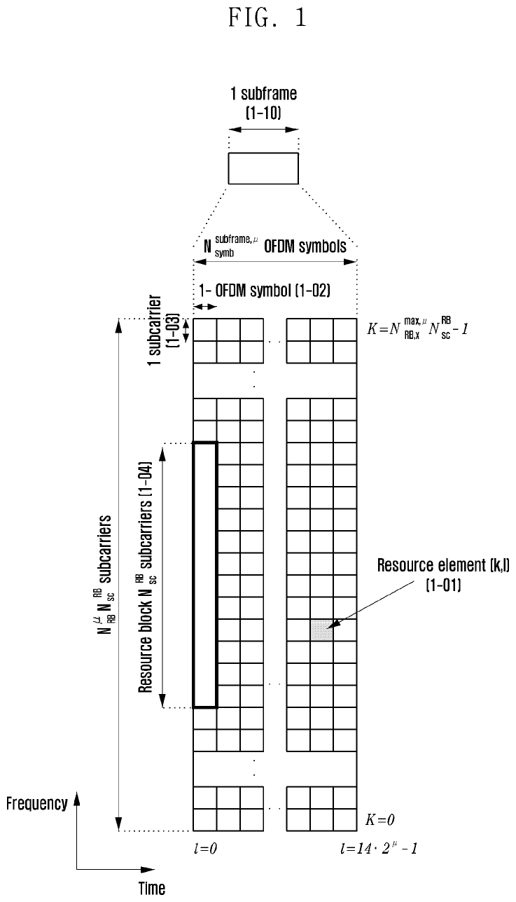

FIG. 1 is a diagram illustrating the basic structure of time-frequency resources in a wireless communication system according to an embodiment of the disclosure. In FIG. 1, the horizontal axis represents the time domain and the vertical axis represents the frequency domain. The basic unit of resources in the time-frequency domain is a resource element (RE) 1-01, which may be defined as 1 OFDM (orthogonal frequency division multiplexing) symbol 1-02 in the time domain and 1 subcarrier 1-03 in the frequency domain. In the frequency domain,

$${N}_{sc}^{RB}$$

(e.g., 12) consecutive REs may constitute one resource block (RB) 1-04. In an embodiment, multiple OFDM symbols may constitute one subframe 1-10.

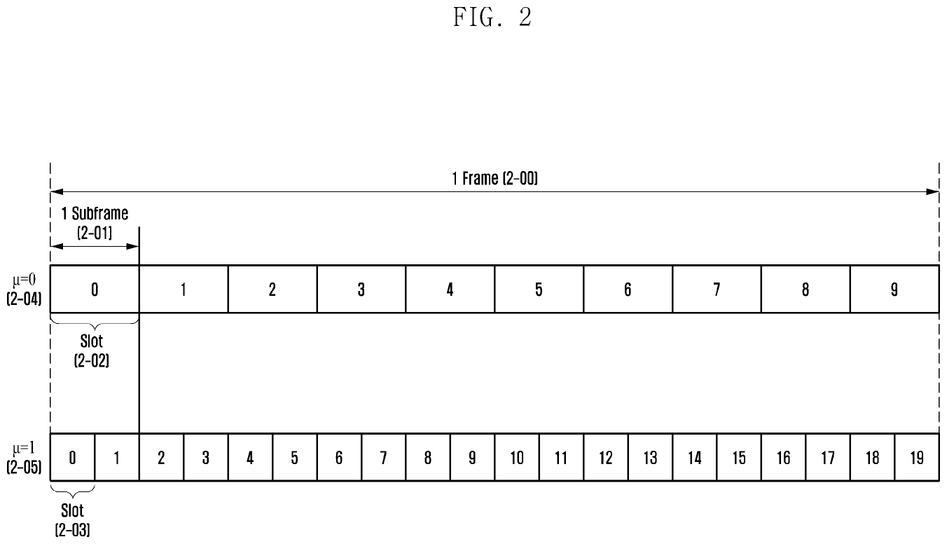

FIG. 2 is a diagram for explaining the frame, subframe, and slot structures in a wireless communication system according to an embodiment of the disclosure. With reference to FIG. 2, one frame 2-00 may be composed of one or more subframes 2-01, and one subframe may be composed of one or more slots 2-02. For example, one frame 2-00 may be defined to be 10 ms. One subframe 2-01 may be defined to be 1 ms, and thus one frame 2-00 may be composed of a total of 10 subframes 2-01. One slot 2-02 or 2-03 may be defined to be 14 OFDM symbols (i.e., the number of symbols per slot

$$( {N}_{symb}^{slot} ) = 14 ) .$$

One subframe 2-01 may be composed of one or multiple slots 2-02 or 2-03, and the number of slots 2-02 or 2-03 per subframe 2-01 may vary according to a configuration value μ (2-04 or 2-05) for the subcarrier spacing. In an example of FIG. 2, a case where μ=0 (2-04) and a case where μ=1 (2-05) are shown as a subcarrier spacing configuration value. When μ=0 (2-04), 1 subframe 2-01 may be composed of 1 slot 2-02, and when μ=1 (2-05), 1 subframe 2-01 may be composed of 2 slots 2-03. That is, according to the configuration value μ for the subcarrier spacing, the number of slots per subframe

$$( {N}_{slot}^{subframe , µ} )$$

may vary, and the number of slots per frame

$$( {N}_{slot}^{frame , µ} )$$

may vary accordingly. According to each configuration value μ for the subcarrier spacing,

$${N}_{slot}^{subframe , µ} and {N}_{slot}^{frame , µ}$$

may be defined as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In NR, a single component carrier (CC) or serving cell may be composed of up to 250 RBs or more. Hence, if the UE always receives the entire serving cell bandwidth like LTE, the power consumption of the UE may be extreme. To solve this, the base station may support the UE to change the reception region within the cell by configuring one or more bandwidth parts (BWPs) to the UE. In NR, the base station may configure the ‘initial BWP’, which is the bandwidth of CORESET #0 (or, common search space (CSS)), to the UE through the MIB (master information block). Thereafter, the base station may configure the first BWP of the UE through RRC signaling and may notify at least one BWP configuration information that may be indicated through downlink control information (DCI) in the future. Thereafter, the base station may instruct the UE which band to use by indicating the BWP ID through a DCI. If the UE fails to receive a DCI from the currently assigned BWP for a specific period of time, the UE may return to the ‘default BWP’ and attempts to receive a DCI.

### <5G Bandwidth Part>

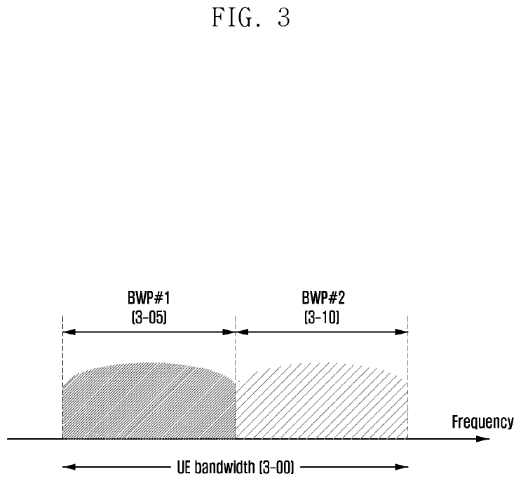

FIG. 3 illustrates an example of bandwidth parts (BWPs) configured in a wireless communication system according to an embodiment of the disclosure.

In FIG. 3, an example is shown in which the UE bandwidth 3-00 is configured as two bandwidth parts, that is, bandwidth part #1 (3-05) and bandwidth part #2 (3-10). The base station may configure one or multiple bandwidth parts to the UE, and the following information may be set for each bandwidth part as shown in Table 2.

TABLE 2
SEQUENCE

| BWP ::= SEQUENCE | |
|---|---|
| bwp-Id | BWP-Id, |
| (Bandwidth part identifier) | |
| locationAndBandwidth | INTEGER (1..65536), |
| (Bandwidth part location) | |
| subcarrierSpacing | ENUMERATED {n0, n1, n2, n3, n4, |
| n5}, | |
| (Subcarrier spacing) | |
| cyclicPrefix | ENUMERATED { extended } |

(Cyclic prefix)
}

Without being limited to the above example, various parameters related to the bandwidth part can be configured to the UE in addition to the above configuration information. These information may be delivered from the base station to the UE through higher layer signaling such as RRC signaling. Among one or multiple configured bandwidth parts, at least one bandwidth part may be activated. Whether a configured bandwidth part is activated may be transmitted from the base station to the UE semi-statically through RRC signaling or dynamically through a MAC CE (control element) or DCI.

According to an embodiment, before being radio resource control (RRC) connected, a UE may be configured by the base station with an initial bandwidth part (initial BWP) for initial access through a master information block (MIB). To be more specific, in the initial access stage, the UE may receive, through the MIB, configuration information about a control resource set (CORESET) and search space through which a physical downlink control channel (PDCCH) for receiving system information required for initial access (remaining system information (RMSI) or system information block 1 (SIB1) can be transmitted. The control resource set and search space configured through the MIB may each be regarded as having an identity (ID) of 0.

The base station may notify the UE of configuration information such as frequency assignment information, time assignment information, and numerology for control resource set #0 through the MIB. Additionally, the base station may notify the UE of configuration information about the monitoring periodicity and occasion for control resource set #0, that is, configuration information about search space #0, through the MIB. The UE may regard the frequency domain set as control resource set #0 obtained from the MIB as the initial bandwidth part for initial access. At this time, the identity (ID) of the initial bandwidth part may be regarded as 0.

The configuration for bandwidth parts supported by the next-generation mobile communication system (5G or NR system) described above may be used for various purposes.

As an example, when the bandwidth supported by the UE is smaller than the system bandwidth, the bandwidth supported by the UE may be supported through a bandwidth part configuration. For example, the base station may configure the frequency location of a bandwidth part (configuration information 2 in Table 2) to the UE, allowing the UE to transmit and receive data at a specific frequency location within the system bandwidth.

As another example, the base station may configure a plurality of bandwidth parts to the UE for the purpose of supporting different numerologies. For example, to support data transmission and reception using both a subcarrier spacing of 15 kHz and a subcarrier spacing of 30 kHz for a specific UE, the base station may configure two bandwidth parts with subcarrier spacings of 15 kHz and 30 kHz, respectively. Different bandwidth parts may be frequency division multiplexed (FDMed), and when intending to transmit and receive data at a specific subcarrier spacing, the bandwidth part configured with the corresponding subcarrier spacing may be activated.

As another example, for the purpose of reducing power consumption of a UE, the base station may configure bandwidth parts with different bandwidth sizes to the UE. For example, if a UE supports a very large bandwidth, for example, a bandwidth of 100 MHz, and always transmits and receives data through that bandwidth, very large power consumption may occur. In particular, monitoring unnecessarily a downlink control channel with a large bandwidth of 100 MHz in a situation where there is no traffic can be very inefficient in terms of power consumption. Hence, for the purpose of reducing the power consumption of the UE, the base station may configure a relatively small bandwidth part, for example, a bandwidth part of 20 MHz, to the UE. The UE may perform monitoring operations on the 20 MHz bandwidth part in a situation where there is no traffic, and may, when data is generated, transmit and receive data in the 100 MHz bandwidth part according to the indication of the base station.

In a method of configuring the bandwidth part described above, a UE before being RRC connected may receive configuration information for an initial bandwidth part through a master information block (MIB) in the initial access stage. To be more specific, through the MIB of the physical broadcast channel (PBCH), the UE may be configured with a control resource set (CORESET) for the downlink control channel through which downlink control information (DCI) scheduling the system information block (SIB) can be transmitted. The bandwidth of the control resource set configured through the MIB may be considered as the initial bandwidth part, and through the configured initial bandwidth part, the UE may receive the physical downlink shared channel (PDSCH) on which the SIB is transmitted. In addition to receiving the SIB, the initial bandwidth part may also be used for other system information (OSI), paging, and random access.

### <SSB/PBCH>

Next, the description will be given of the synchronization signal (SS)/PBCH block (SSB) in a next-generation mobile communication system (5G or NR system). The SS/PBCH block may indicate a physical layer channel block including a primary SS (PSS), a secondary SS (SSS), and a PBCH. More specifically, the SS/PBCH block may be defined as follows.
PSS: PSS is a signal that serves as a reference for downlink time/frequency synchronization and provides some information of cell ID.
SSS: SSS serves as a reference for downlink time/frequency synchronization and provides remaining cell ID information not provided by PSS. Additionally, it may serve as a reference signal (RS) for demodulation of the PBCH.
PBCH: PBCH may provide essential system information required for transmission and reception of a data channel and control channel of the UE. The essential system information may include search space-related control information indicating radio resource mapping information of a control channel, scheduling control information of a separate data channel for transmitting system information, and the like.
SS/PBCH block: the SS/PBCH block may be composed of a combination of PSS, SSS, and PBCH. One or multiple SS/PBCH blocks may be transmitted within 5 ms, and individual SS/PBCH blocks being transmitted may be distinguished by an index.

The UE may detect the PSS and SSS in the initial access stage, and may decode the PBCH. The UE may obtain the MIB from the PBCH, and may be configured with control resource set (CORESET) #0 through the MIB. The UE may assume that a selected SS/PBCH block and a demodulation reference signal (DMRS) transmitted in control resource set #0 are quasi-colocated (QCLed), and may perform monitoring of control resource set #0. The UE may obtain system information through downlink control information transmitted in control resource set #0. The UE may obtain random access channel (RACH)-related configuration information required for initial connection from the received system information. The UE may transmit a physical RACH (PRACH) to the base station in consideration of the selected SS/PBCH block index, and the base station having received the PRACH may obtain information about the SS/PBCH block index selected by the UE. The base station may know that the UE has selected a specific block among individual SS/PBCH blocks and monitors control resource set #0 related to (associated with) the selected SS/PBCH block.

### <PDCCH: DCI>

Next, a detailed description will be given of downlink control information (DCI) in a next-generation mobile communication system (5G or NR system).

In the next-generation mobile communication system (5G or NR system), scheduling information regarding uplink data (or, physical uplink shared channel (PUSCH)) or downlink data (or, physical downlink shared channel (PDSCH)) may be delivered from the base station to the UE through DCI. The UE may monitor a fallback DCI format and a non-fallback DCI format for the PUSCH or PDSCH. A fallback DCI format may include fixed fields predefined between the base station and the UE, and a non-fallback DCI format may include fields that may be configurable.

DCI may be transmitted over a physical downlink control channel (PDCCH), which is a physical downlink control channel, through a channel coding and modulation process. A cyclic redundancy check (CRC) may be attached to the payload of a DCI message, and the CRC may be scrambled with a radio network temporary identifier (RNTI) corresponding to the identity of the UE. Different RNTIs may be used for scrambling the CRC attached to the payload of the DCI message according to the purpose of the DCI message, for example, UE-specific data transmission, power control command, or random access response. That is, the RNTI is not explicitly transmitted, but is transmitted by being included in the CRC calculation process. Upon receiving a DCI message transmitted over the PDCCH, the UE may perform a CRC check by using the assigned RNTI. If the CRC check result is correct, the UE may know that the corresponding message has been transmitted to it.

For example, DCI for scheduling a PDSCH for system information (SI) may be scrambled with an SI-RNTI. DCI for scheduling a PDSCH for a random access response (RAR) message may be scrambled with an RA-RNTI. DCI for scheduling a PDSCH for a paging message may be scrambled with a P-RNTI. DCI for notifying a slot format indicator (SFI) may be scrambled with an SFI-RNTI. DCI for notifying transmit power control (TPC) may be scrambled with a TPC-RNTI. DCI for scheduling UE-specific PDSCH or PUSCH may be scrambled with C-RNTI (cell RNTI).

DCI format 0_0 may be used as fallback DCI for scheduling a PUSCH, where the CRC may be scrambled with a C-RNTI. In an embodiment, DCI format 0_0 having a CRC scrambled with a C-RNTI may include the following information as shown in Table 3.

```
TABLE 3
  - Identifier for DCI formats (DCI format identifier)-[1]bit
  - Frequency domain resource assignment (frequency domain
$resource assignment ) \text{-[} ⌈ {log}_{2} ( {N}_{RB}^{UL , BWP} ( {N}_{RB}^{UL , BWP} + 1 ) / 2 ) ⌉ ] bits$
  - Time domain resource assignment (Time domain resource
assignment)-X bits
  - Frequency hopping flag (Frequency hopping flag)-1 bit.
  - Modulation and coding scheme (Modulation and coding scheme)-
5 bits
  - New data indicator (New data indicator)-1 bit
  - Redundancy version (Redundancy version)-2 bits
  - HARQ process number (HARQ process number)-4 bits
  - TPC command for scheduled PUSCH (Transmit power control
(TPC) command for scheduled PUSCH-[2] bits
  - UL/SUL indicator (Uplink (UL)/supplementary UL (SUL)
indicator
)-0 or 1 bit
```

DCI format 0_1 may be used as non-fallback DCI for scheduling a PUSCH, where the CRC may be scrambled with a C-RNTI. In an embodiment, DCI format 0_1 having a CRC scrambled with a C-RNTI may include the following information as shown in Table 4.

```
TABLE 4
  - Carrier indicator (Carrier indicator)-0 or 3 bits
  - UL/SUL indicator-0 or 1 bit
  - Identifier for DCI formats-[1] bits
  - Bandwidth part indicator (Bandwidth part indicator)-0, 1 or 2
bits
  - Frequency domain resource assignment
      • For resource allocation type 0(For resource allocation type
        $0 ) , ⌈ {N}_{RB}^{UL , BWP} / P ⌉ bits$
      • For resource allocation type 1(For resource allocation type
          $1 ) , ⌈ {log}_{2} ( {N}_{RB}^{UL , BWP} ( {N}_{RB}^{UL , BWP} + 1 ) / 2 ) ⌉ bits$
  - Time domain resource assignment-1, 2, 3, or 4 bits
  - VRB-to-PRB mapping (virtual resource block-to-physical
resource block mapping)-0 or 1 bit, only for resource allocation type 1.
      • 0 bit if only resource allocation type 0 is configured;
      • 1 bit otherwise.
  - Frequency hopping flag-0 or 1 bit, only for resource allocation
type 1.
      • 0 bit if only resource allocation type 0 is configured;
      • 1 bit otherwise.
  - Modulation and coding scheme-5 bits
  - New data indicator-1 bit
  - Redundancy version-2 bits
  - HARQ process number-4 bits
  - 1st downlink assignment index (1st downlink assignment index)-
1 or 2 bits
      • 1 bit for semi-static HARQ-ACK codebook (for semi-static
          HARQ-ACK codebook);
      • 2 bits for dynamic HARQ-ACK codebook with single
          HARQ-ACK codebook (for dynamic HARQ-ACK
        codebook with single HARQ-ACK codebook).
  - 2nd downlink assignment index (2nd downlink assignment index)-
  - 0 or 2 bits
      • 2 bits for dynamic HARQ-ACK codebook with two
        HARQ-ACK sub-codebooks (for dynamic HARQ-ACK
        codebook with two HARQ-ACK sub-codebooks);
      • 0 bit otherwise.
  - TPC command for scheduled PUSCH-2 bits
  - SRS resource indicator (SRS resource indicator)-
$⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
      $⌈ {log}_{2} ( {\sum }_{k = 1}^{{L}_{max}} ( \begin{matrix}{N}_{SRS} \\ k\end{matrix} ) ) ⌉ bits for non - codebook based PUSCH$
        transmission (for non-codebook based PUSCH
        transmission);
      • ┌log2 (NSRs)┐ bits for codebook based PUSCH transmission
      (for codebook based PUSCH transmission).
  - Precoding information and number of layers (Precoding
information and number of layers)-up to 6 bits
  - Antenna ports (Antenna ports)-up to 5 bits
  - SRS request (SRS request)-2 bits
  - CSI request (Channel state information request)-0, 1, 2, 3, 4, 5,
or 6 bits
  - CBG transmission information (code block group transmission
information)-0, 2, 4, 6, or 8 bits
  - PTRS-DMRS association (Phase tracking reference signal-
demodulation reference signal relationship)-0 or 2 bits.
  - beta_offset indicator (beta_offset indicator)-0 or 2 bits
  - DMRS sequence initialization (Demodulation reference signal
sequence initialization)-0 or 1 bit
```

DCI format 1_0 may be used as fallback DCI for scheduling a PDSCH, where the CRC may be scrambled with a C-RNTI. In an embodiment, DCI format 1_0 having a CRC scrambled with a C-RNTI may include the following information as shown in Table 5.

```
TABLE 5
  - Identifier for DCI formats-[1] bit
  - Frequency domain resource assignment-
$[ ⌈ {log}_{2} ( {N}_{RB}^{DL , BWP} ( {N}_{RB}^{DL , BWP} + 1 ) / 2 ) ⌉ ] bits$
  - Time domain resource assignment-X bits
  - VRB-to-PRB mapping-1 bit.
  - Modulation and coding scheme-5 bits
  - New data indicator-1 bit
  - Redundancy version-2 bits
  - HARQ process number-4 bits
  - Downlink assignment index-2 bits
  - TPC command for scheduled PUCCH-[2] bits
  - PUCCH resource indicator (PUCCH (physical uplink control
channel) resource indicator-3 bits
  - PDSCH-to-HARQ feedback timing indicator (PDSCH-to-HARQ
feedback timing indicator)-[3] bits
```

Alternatively, DCI format 1_0 may be used as a DCI for scheduling a PDSCH for the RAR message, where the CRC may be scrambled with a RA-RNTI. DCI format 1_0 having a CRC scrambled with a C-RNTI may include the following information as shown in Table 6.

TABLE 6

```
  - Frequency domain resourcce assignment-
    $⌈ {log}_{2} ( {N}_{RB}^{DL , BWP} ( {N}_{RB}^{DL , BWP} + 1 ) / 2 ) ⌉ bits$
  - Time domain resource assignment-4 bits
  - VAB-to-PRB mapping-1 bit
  - Modulation and coding scheme-5 bits
  - TB scaling-2 bits
  - Reserved bits-16 bits
```

DCI format 1_1 may be used as non-fallback DCI for scheduling a PDSCH, where the CRC may be scrambled with a C-RNTI. In an embodiment, DCI format 1_1 having a CRC scrambled with a C-RNTI may include the following information as shown in Table 7.

```
TABLE 7
  - Carrier indicator-0 or 3 bits
  - Identifier for DCI formats[1] bits
  - Bandwidth part indicator-0, 1 or 2 bits
  - Frequency domain resource assignment
      $For resource allocation type 0 , ⌈ {N}_{RB}^{DL , BWP} / P ⌉ bits$
      • For resource allocation type 1,
        $⌈ {log}_{2} ( {N}_{RB}^{DL , BWP} ( {N}_{RB}^{DL , BWP} + 1 ) / 2 ) ⌉ bits$
  - Time domain resource assignment-1, 2, 3, or 4 bits
  - VRB-to-PRB mapping-0 or 1 bit, only for resource allocation
type 1.
      • 0 bit if only resource allocation type 0 is configured;
      • 1 bit otherwise.
  - PRB bundling size indicator (PRB bundling size indicator)-0 or
1 bit
  - Rate matching indicator (Rate matching indicator)-0, 1, or 2 bits
  - ZP CSI-RS trigger (ZP CSI-RS trigger)-0, 1, or 2 bits
For transport block 1 (For transport block 1):
  - Modulation and coding scheme-5 bits
  - New data indicator-1 bit
  - Redundancy version-2 bits
  For transport block 2(For transport block 2):
  - Modulation and coding scheme-5 bits
  - New data indicator-1 bit
  - Redundancy version-2 bits
  - HARQ process number-4 bits
  - Downlink assignment index-0 or 2 or 4 bits
  - TPC command for scheduled PUCCH-2 bits
  - PUCCH resource indicator-3 bits
  - PDSCH-to-HARQ_feedback timing indicator-3 bits
  - Antenna ports-4, 5 or 6 bits
  - Transmission configuration indication (Transmission
configuration indication)-0 or 3 bits
  - SRS request-2 bits
  - CBG transmission information-0, 2, 4, 6, or 8 bits
  - CBG flushing out information (Code block group flushing out
information)-0 or 1 bit
  - DMRS sequence initialization-1 bit
```

### <PDCCH, PDSCH QCL Rule Related>

Next, a detailed description will be given of QCL prioritization for the PDCCH. In the case where the UE operates on carrier aggregation in a single cell or band and where plural control resource sets present in activated bandwidth parts of a single or multiple cells have the same or different QCL-TypeD characteristics in a specific PDCCH monitoring occasion and overlap in time, the UE may select a specific control resource set according to QCL prioritization operation and monitor control resource sets having the same QCL-TypeD characteristic as the selected control resource set. That is, when multiple control resource sets overlap in time, only one QCL-TypeD characteristic may be received. In this case, the criteria for QCL prioritization may be as follows.
Criterion 1. The control resource set associated to a common search space having the lowest index in a cell corresponding to the lowest index among the cells including common search spaces
Criterion 2. The control resource set associated to a UE-specific search space having the lowest index in a cell corresponding to the lowest index among the cells including UE-specific search spaces

As described above, if each of the above criteria is not met, the next criterion may be applied. For example, when control resource sets overlap in time in a specific PDCCH monitoring occasion, if all the control resource sets are associated to a UE-specific search space but not to a common search space, that is, if criterion 1 is not met, the UE may omit application of criterion 1 and apply criterion 2.

When selecting control resource sets according to the above-described criteria, the UE may further consider the following two items in relation to QCL information configured in the control resource set. First, if control resource set 1 has CSI-RS 1 as a reference signal having a QCL-TypeD relationship, and a reference signal having a QCL-TypeD relationship with CSI-RS 1 is SSB 1, and if a reference signal with which control resource set 2 has a QCL-TypeD relationship is SSB 1, the UE may consider that two control resource sets 1 and 2 have different QCL-TypeD characteristics. Second, if control resource set 1 has CSI-RS 1 configured in cell 1 as a reference signal having a QCL-TypeD relationship, and a reference signal with which CSI-RS 1 has a QCL-TypeD relationship is SSB 1, and if control resource set 2 has CSI-RS 2 configured in cell 2 as a reference signal having a QCL-TypeD relationship, and a reference signal with which CSI-RS 2 has a QCL-TypeD relationship is SSB 1, the UE may consider that the two control resource sets have the same QCL-TypeD characteristic.

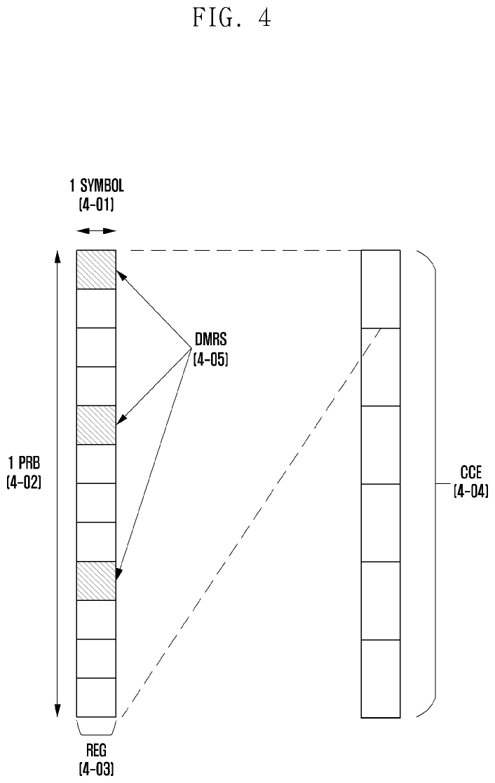

FIG. 4 is a diagram illustrating the structure of a downlink control channel in a wireless communication system according to an embodiment of the disclosure. That is, FIG. 4 is a diagram showing an example of the basic unit of time-frequency resources constituting a downlink control channel that may be used in 5G according to an embodiment of the disclosure.

With reference to FIG. 4, the basic unit of time-frequency resources constituting a control channel may be defined to be a resource element group (REG) 4-03. The REG 4-03 may be defined as one OFDM symbol 4-01 in the time domain and one physical resource block (PRB) 4-02, that is, 12 subcarriers, in the frequency domain. The base station may concatenate REGs 4-03 to compose a downlink control channel allocation unit.

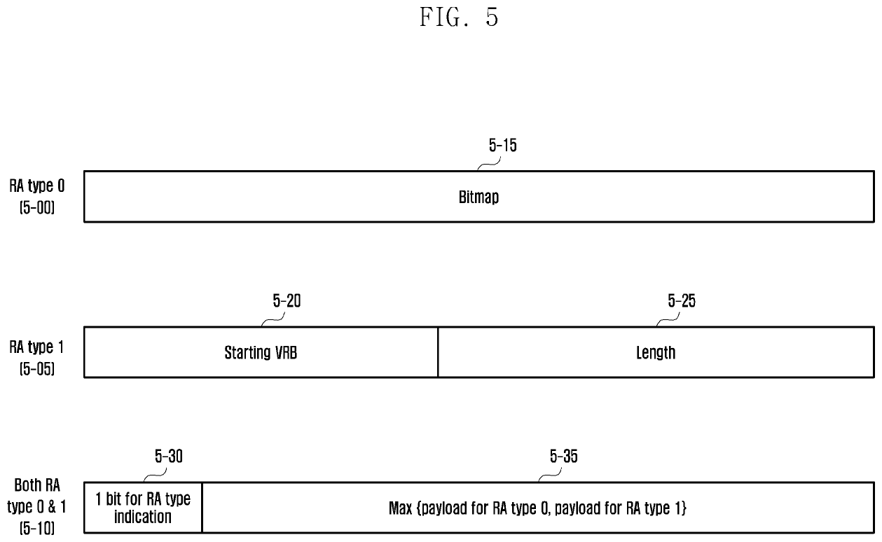

As illustrated in FIG. 4, when the basic unit to which the downlink control channel is assigned in the 5G wireless communication system is a control channel element (CCE) 4-04, one CCE 4-04 may be composed of plural REGs 4-03. Taking the REG 4-03 shown in FIG. 5 as an example, when the REG 4-03 includes 12 REs and one CCE 4-04 includes 6 REGs 4-03, one CCE 4-04 may include 72 REs. When a downlink control resource set is configured, the corresponding region may be composed of multiple CCEs 4-04, and a specific downlink control channel may be transmitted after being mapped to one or multiple CCEs 4-04 according to an aggregation level (AL) in the control resource set. The CCEs 4-04 in a control resource set may be identified by numbers, in which case the numbers may be assigned to the CCEs 4-04 according to a logical mapping scheme.

The basic unit of the downlink control channel illustrated in FIG. 4, that is, the REG 4-03, may include both REs to which the DCI is mapped and a region to which a DMRS 4-05 being a reference signal for decoding the DCI is mapped. As illustrated in FIG. 4, three DMRSs 4-05 may be transmitted in one REG 4-03. The number of CCEs required to transmit the PDCCH may be 1, 2, 4, 8, or 16 according to the aggregation level (AL), and different number of CCEs may be used to implement link adaptation of the downlink control channel. For example, when AL=L, one downlink control channel may be transmitted through L CCEs.

The UE has to detect a signal without having information about the downlink control channel, and a search space representing a set of CCEs may be defined for blind decoding. The search space may refer to a set of downlink control channel candidates composed of CCEs to which the UE has to attempt decoding on a given aggregation level. Because there are various aggregation levels that groups 1, 2, 4, 8, or 16 CCEs into one bundle, the UE may have plural search spaces. The search space set may be defined as a set of search spaces at all configured aggregation levels.

Search spaces may be classified as a common search space and a UE-specific search space. According to an embodiment of the disclosure, a group of UEs or all UEs may search for a common search space of the PDCCH to receive cell-common control information such as dynamic scheduling of system information or a paging message.

For example, the UE may receive PDSCH scheduling allocation information for transmitting an SIB including cell operator information or the like by searching for the common search space of the PDCCH. In the case of a common search space, since a group of UEs or all UEs need to receive the PDCCH, the common search space may be defined as a set of CCEs agreed upon in advance. Meanwhile, the UE may receive scheduling allocation information for a UE-specific PDSCH or PUSCH by searching for a UE-specific search space of the PDCCH. A UE-specific search space may be defined in a UE-specific way as a function of UE identity and various system parameters.

In 5G, search space parameters for the PDCCH may be configured by the base station to the UE via higher layer signaling (e.g., SIB, MIB, or RRC signaling). For example, the base station may configure, to the UE, the number of PDCCH candidates at each aggregation level L, a periodicity of monitoring the search space, a search space monitoring occasion in units of symbols within a slot, a search space type (common search space or UE-specific search space), a DCI format-RNTI combination to be monitored in a corresponding search space, a control resource set index at which a search space is to be monitored, and the like. For example, this configuration may include the following information as shown in Table 8.

TABLE 8

| | |
|---|---|
| SearchSpace ::= | SEQUENCE { |

```
  -- Identity of the search space. SearchSpaceId = 0 identifies the
        SearchSpace configured through PBCH (MIB) or ServingCell
      ConfigCommon.
```

| | |
|---|---|
| searchSpaceId | SearchSpaceId, |

(Search Space Identity)

| | |
|---|---|
| controlResourceSetId | ControlResourceSetId, |

(Control resource set Identity)

| | |
|---|---|
| monitoringSlotPeriodicityAndOffset | CHOICE { |

(Monitoring Slot Level Periodicity)

| | |
|---|---|
| sl1 | NULL, |
| sl2 | INTEGER (0..1), |
| sl4 | INTEGER (0..3), |
| sl5 | INTEGER (0.4), |
| sl8 | INTEGER (0..7), |
| sl10 | INTEGER (0..9), |
| sl16 | INTEGER (0..15), |
| s120 | INTEGER (0..19) |
| } | OPTIONAL, |
| duration(Monitoring Length) | INTEGER (2..25 |

59)

| | |
|---|---|
| monitoringSymbolsWithinSlot | BIT STRING (SIZE |
| (14)) | OPTIONAL, |

(Monitoring Symbol in Sot)

| | |
|---|---|
| nrofCandidates | SEQUENCE { |

(The Number of PDCCH Candidates per Aggregation Level)

| | |
|---|---|
| aggregationLevel1 | ENUMERATED {n0, n1, |

n2, n3, n4, n5, n6, n8},

| | |
|---|---|
| aggregationLevel2 | ENUMERATED {n0, n1, |

n2, n3, n4, n5, n6, n8},

| | |
|---|---|
| aggregationLevel4 | ENUMERATED {n0, n1, |

n2, n3, n4, n5, n6, n8},

| | |
|---|---|
| aggregationLevel8 | ENUMERATED {n0, n1, |

n2, n3, n4, n5, n6, n8},

| | |
|---|---|
| aggregationLevel16 | ENUMERATED {n0, n1, |

```
      n2, n3, n4, n5, n6, n8}
  },
```

| | |
|---|---|
| searchSpaceType | CHOICE { |

```
  (Search Space Type)
      -- Configures this search space as common search space (CSS
      ) and DCI formats to monitor.
```

| | |
|---|---|
| common | SEQUENCE { |

(Common Search Space)

| | |
|---|---|
| } | |
| ue-Specific | SEQUENCE { |

```
  (UE-Specific Search Space)
          -- Indicates whether the UE monitors in this USS for DCI f
    ormats 0-0 and 1-0 or for formats 0-1 and 1-1
```

| | |
|---|---|
| formats | ENUMERATED {forma |

```
    ts0-0-And-1-0, formats0-1-And-1-1},
          ...
      }
```

Based on the configuration information, the base station may configure one or multiple search space sets to the UE. According to an embodiment of the disclosure, the base station may configure the UE with search space set 1 and search space set 2 so as to monitor DCI format A scrambled with X-RNTI in a common search space of search space set 1, and monitor DCI format B scrambled with Y-RNTI in a UE-specific search space of search space set 2.

According to the configuration information, one or multiple search space sets may be present in a common search space or a UE-specific search space. For example, search space set #1 and search space set #2 may be configured as a common search space, and search space set #3 and search space set #4 may be configured as a UE-specific search space.

Common search spaces may be classified into search space sets of specific types according to the purpose. The RNTIs to be monitored may be different for the specific type of search space sets. For example, common search space types, purposes, and RNTIs to be monitored may be classified as shown in Table 9 below.

TABLE 9

| Search Space Type | Purpose | RNTI |
|---|---|---|
| Type0 CSS | PDCCH transmission | SI-RNTI |
| | for SIB scheduling | |
| Type0A CSS | PDCCH transmission | SI-RNTI |
| | for other SI scheduling | |
| | (such as SIB2) except | |
| | for SIB1 | |
| Type1 CSS | PDCCH transmission | RA-RNTI, TC-RNTI |
| | for RAR (random | |
| | access response) | |
| | scheduling, Msg3 | |
| | retransmission | |
| | scheduling, Msg4 | |
| | scheduling | |
| Type2 CSS | Paging | P-RNTI |
| Type3 CSS | group control | INT-RNTI, SFI- |
| | information | RNTI, TPC-PUSCH- |
| | transmission | RNTI, TPC-PUCCH- |
| | | RNTI, TPC-SRS- |
| | | RNTI |
| | in case of PCell, | C-RNTI, MCS-C- |
| | PDCCH transmission | RNTI, CS-RNTI |
| | for data scheduling | |

Meanwhile, in a common search space, the following combination of a DCI format and an RNTI may be monitored. However, it is not limited to the examples below.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In a UE-specific search space, the following combination of a DCI format and an RNTI may be monitored. However, it is not limited to the examples below.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The above-mentioned RNTIs may follow the definition and usage described below.
C-RNTI (cell RNTI): used for scheduling UE-specific PDSCH
TC-RNTI (temporary cell RNTI): used for scheduling UE-specific PDSCH
CS-RNTI (configured scheduling RNTI): used for scheduling semi-statically configured UE-specific PDSCH
RA-RNTI (random access RNTI): used for scheduling PDSCH at random access stage
P-RNTI (paging RNTI): used for scheduling PDSCH in which paging is transmitted
SI-RNTI (system information RNTI): used for scheduling PDSCH in which system information is transmitted
INT-RNTI (interruption RNTI): used for indicating whether to perform puncturing on PDSCH
TPC-PUSCH-RNTI (transmit power control for PUSCH RNTI): used for issuing a power control command for PUSCH
TPC-PUCCH-RNTI (transmit power control for PUCCH RNTI): used for issuing a power control command for PUCCH
TPC-SRS-RNTI (transmit power control for SRS RNTI): used for issuing a power control command for SRS

In an embodiment, the DCI formats specified above may be defined as shown in Table 10 below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH In one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and PUSCH |
| 2_3 | Transmission of a group of TPC commands for SRS |
| | transmissions by one or more UEs |

According to an embodiment of the disclosure, in 5G, a plurality of search space sets may be configured with different parameters (e.g., parameters in Table 8). So, the group of search space sets monitored by the UE may vary at each time point. For example, if search space set #1 is configured with a X-slot periodicity, and search space set #2 is configured with a Y-slot periodicity, where X and Y are different, the UE may monitor both search space set #1 and search space set #2 in a specific slot, and may monitor either search space set #1 or search space set #2 in another specific slot.

In the case where a plurality of search space sets is configured to the UE, the following conditions may be considered for determining a search space set to be monitored by the UE.

### [Condition 1: Limitation on Maximum Number of PDCCH Candidates]

The number of PDCCH candidates that can be monitored per slot may not exceed M^{μ}. M^{μ} may be defined as the maximum number of PDCCH candidates per slot in a cell with a subcarrier spacing of 15.24 kHz, and may be defined as shown in Table 11 below.

TABLE 11

| | Maximum number of PDCCH candidates |
|---|---|
| μ | per slot and per serving cell (M^{μ}) |
| 0 | 44 |
| 1 | 36 |
| 2 | 22 |
| 3 | 20 |

### [Condition 2: Limitation on Maximum Number of CCEs]

The number of CCEs constituting the entire search space per slot (here, the entire search space may mean the entire CCE set corresponding to the union of multiple search space sets) may not exceed CH. CH may be defined as the maximum number of CCEs per slot in a cell with a subcarrier spacing of 15·2^{μ} kHz, and may be defined as shown in Table 12 below.

TABLE 12

| | Maximum number of CCEs per |
|---|---|
| μ | slot and per serving cell (C^{μ}) |
| 0 | 56 |
| 1 | 56 |
| 2 | 48 |
| 3 | 32 |

For convenience of explanation, a situation that satisfies both condition 1 and condition 2 at a specific time is defined as “condition A”. Hence, a situation that does not satisfy condition A may indicate that the situation does not satisfy at least one of condition 1 or condition 2 above.

Condition A may be not satisfied at a specific time depending on the configuration of search space sets by the base station. If condition A is not satisfied at a specific time, the UE may select and monitor only some of the search space sets configured so as to satisfy condition A at that time, and the base station may transmit a PDCCH through the selected search space set.

According to an embodiment of the disclosure, selection of some search spaces from among the total configured search space sets may be performed according to the following methods.

### [Method 1]

In case that condition A for the PDCCH is not satisfied at a specific time (slot), The UE (or the base station) may select a search space set whose search space type is a common search space from among the search space sets present at the corresponding time in preference to a search space set whose search space type is a UE-specific search space.

If all search space sets configured as a common search space are selected (i.e., condition A is still satisfied even after selecting all search spaces configured as a common search space), the UE (or the base station) may select search space sets configured as a UE-specific search space. Here, if there are a plurality of search space sets configured as a UE-specific search space, the search space set having a lower search space set index may have a higher priority. The UE or base station may select UE-specific search space sets within the range where condition A is satisfied in consideration of priority.

Next, a description will be given of methods for allocating time and frequency resources for data transmission in NR.

In addition to frequency domain resource candidate allocation through BWP indication, NR may provide the following methods for detailed frequency domain resource allocation (FD-RA).

FIG. 5 is a diagram illustrating an example of frequency domain resource allocation for the physical downlink shared channel (PDSCH) in a wireless communication system according to an embodiment of the disclosure.

FIG. 5 is a diagram showing three frequency domain resource allocation methods of type 0 (5-00), type 1 (5-05), and dynamic switch (5-10) that may be configured through a higher layer in NR.

With reference to FIG. 5, if the UE is configured to use only resource type 0 through higher layer signaling (5-00), some of downlink control information (DCI) allocating the PDSCH to the UE has a bitmap of NRBG bits. The conditions for this will be described later. Here, NRBG indicates the number of RBGs (resource block groups) determined as shown in Table 13 below according to the BWP size allocated by a BWP indicator and higher layer parameter rbg-Size, and data is transmitted on the RBG indicated to be ‘l’ by the bitmap.

TABLE 13

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

If the UE is configured to use only resource type 1 through higher layer signaling (6-05), some DCI for allocating the PDSCH to the UE includes frequency domain resource allocation information composed of

$$⌈ {log}_{2} ( {N}_{RB}^{DL , BWP} ( {N}_{RB}^{DL , BWP} + 1 ) / 2 ⌉ bits .$$

The conditions for this will be described later. Thereby, the base station may configure a starting VRB 6-20 and a length 6-25 of frequency domain resources allocated successively therefrom.

If the UE is configured to use both resource type 0 and resource type 1 through higher layer signaling (5-10), some DCI allocating the PDSCH to the UE includes frequency domain resource allocation information composed of bits corresponding to a larger value 5-35 of a payload 5-15 for configuring resource type 0 and a payload 5-20 and 5-25 for configuring resource type 1. The conditions for this will be described later. In this case, one bit may be prepended to the front part (MSB) of the frequency domain resource allocation information in DCI; if the bit has a value of ‘0’, it may indicate that resource type 0 is used, and if the bit has a value of ‘1’, it may indicate that resource type 1 is used.

Next, a description will be given of time domain resource allocation for the data channel in a next-generation mobile communication systems (5G or NR systems).

The base station may configure the UE with a table for time domain resource allocation information about a downlink data channel (physical downlink shared channel, PDSCH) and an uplink data channel (physical uplink shared channel, PUSCH) by using higher layer signaling (e.g., RRC signaling). A table composed of up to maxNrofDL−Allocations=16 entries may be configured for the PDSCH, and a table composed of up to maxNrofUL−Allocations=16 entries may be configured for the PUSCH. In one embodiment, the time domain resource allocation information may include PDCCH-to-PDSCH slot timing (corresponding to the time gap in slots between the time at which the PDCCH is received and the time at which the PDSCH scheduled by the received PDCCH is transmitted, denoted by K0), PDCCH-to-PUSCH slot timing (corresponding to the time gap in slots between the time at which the PDCCH is received and the time at which the PUSCH scheduled by the received PDCCH is transmitted, denoted by K2), information about the start position and length of symbols in the slot at which the PDSCH or PUSCH is scheduled, a mapping type for the PDSCH or PUSCH, and the like. For example, information as shown in Table 14 or Table 15 below may be transmitted from the base station to the UE.

```
TABLE 14
PDSCH-TimeDomainResourceAllocationList information element
PDSCH-TimeDomainResourceAllocationList ::= SEQUENCE
(SIZE(1..maxNrofDL-Allocations)) OF PDSCH-
TimeDomainResourceAllocation
PDSCH-TimeDomainResourceAllocation ::= SEQUENCE {
  k0
INTEGER(0..32)
OPTIONAL, -- Need S
  mappingType ENUMERATED
{typeA, typeB},
  startSymbolAndLength INTEGER
(0..127)
}
```

```
TABLE 15
PUSCH-TimeDomainResourceAllocation information element
PUSCH-TimeDomainResourceAllocationList ::= SEQUENCE
(SIZE(1..maxNrofUL-Allocations)) OF PUSCH-
TimeDomainResourceAllocation
PUSCH-TimeDomainResourceAllocation ::= SEQUENCE {
  k2
INTEGER(0..32) OPTIONAL, -- Need S
  mappingType ENUMERATED
{typeA, typeB},
  startSymbolAndLength INTEGER
(0..127)
}
```

The base station may notify the UE of one of the entries in the table for the time domain resource allocation information described above through L1 signaling (e.g., DCI) (for example, may be indicated by field “time domain resource assignment” in DCI). The UE may obtain time domain resource allocation information for the PDSCH or PUSCH based on the DCI received from the base station.

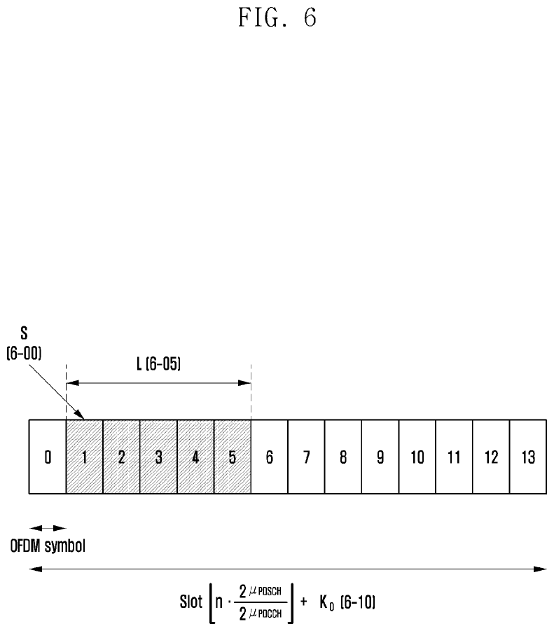

FIG. 6 is a diagram illustrating an example of time domain resource allocation for the PDSCH in a wireless communication system according to an embodiment of the disclosure.

With reference to FIG. 6, the base station may indicate the time domain position of a PDSCH resource according to the subcarrier spacings (SCS) (μ_{PDSCH}, μ_{PDCCH}) of the data channel and control channel configured using a higher layer, a slot offset value (K₀), a start position 6-00 and length 6-05 of OFDM symbols in a slot dynamically indicated through DCI.

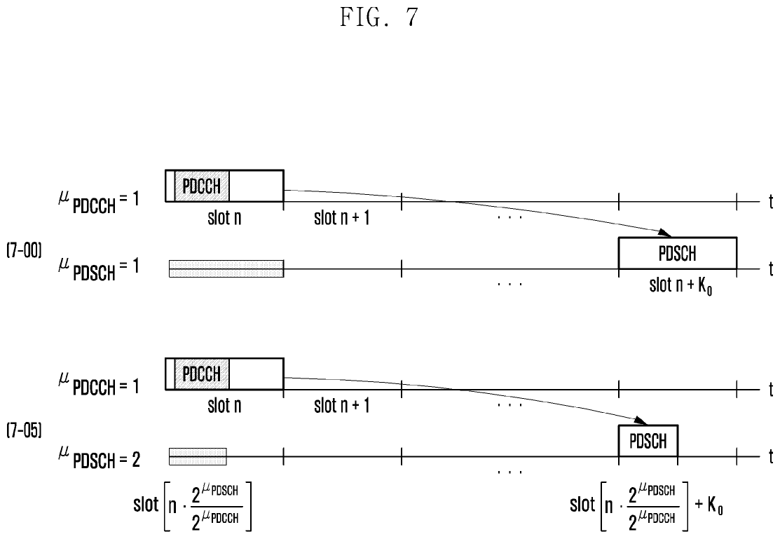

FIG. 7 is a diagram illustrating an example of time domain resource allocation based on the subcarrier spacing of a data channel and a control channel in a wireless communication system according to an embodiment of the disclosure. With reference to FIG. 7, if the subcarrier spacing of the data channel is the same as that of the control channel (7-00, μ_{PDSCH}=μ_{PDCCH}), the slot numbers for the data and the control are the same, so the base station and the UE may produce a scheduling offset according to a preset slot offset K₀. On the other hand, if the subcarrier spacing of the data channel is different from that of the control channel (7-05, μ_{PDSCH}≠μ_{PDCCH}), the slot numbers for the data and the control are different from each other, so the base station and the UE may produce a scheduling offset according to a preset slot offset K₀ with respect to the subcarrier spacing of the PDCCH.

### <QCL, TCI State>

In a wireless communication system, one or more different antenna ports (these may be replaced with one or more channels, signals, or a combination thereof, but will be collectively referred to as “different antenna ports” in the following description of the disclosure for convenience) may be associated with each other according to quasi co-location (QCL) configuration as shown in Table 16 below. The TCI state is intended to notify a QCL relationship between a PDCCH (or PDCCH DMRS) and another RS or channel; when a specific reference antenna port A (reference RS #A) and another target antenna port B (target RS #B) are quasi co-located (QCLed), this indicates that the UE is allowed to apply some or all of large-scale channel parameters estimated from the antenna port A to channel measurement from the antenna port B. QCL may be required to associate different parameters depending on the situation, such as 1) time tracking affected by average delay and delay spread, 2) frequency tracking affected by Doppler shift and Doppler spread, 3) radio resource management (RRM) affected by average gain, 4) beam management (BM) affected by spatial parameters, and the like. Accordingly, NR supports four types of QCL relationships as shown in Table 16 below.

TABLE 16

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

Spatial RX parameters may refer to some or all of various parameters such as angle of arrival (AoA), power angular spectrum (PAS) of AoA, angle of departure (AoD), PAS of AoD, transmit/receive channel correlation, transmit/receive beamforming, spatial channel correlation, and the like.

The QCL relationship may be configured to the UE through RRC parameters TCI-State and QCL-Info as shown in Table 17 below. With reference to Table 17, the base station may configure one or more TCI states for the UE and notify the UE of up to two QCL relationships (qcl-Type1 and qcl-Type2) about the RS With reference to the ID of a TCI state, that is, the target RS. Here, each piece of QCL information (QCL-Info) included in each TCI state includes a serving cell index and a BWP index associated with the reference RS indicated by the corresponding QCL information, the type and ID of the reference RS, and the QCL type as shown in Table 16 above.

TABLE 17

| | |
|---|---|
| TCI-State ::= | SEQUENCE { |
| tci-StateId | TCI-StateId, |
| qcl-Type1 | QCL-Info, |
| qcl-Type2 | QCL-Info |
| OPTIONAL, -- Need R | |
| ... | |
| } | |
| QCL-Info ::= | SEQUENCE { |
| cell | ServCellIndex |
| OPTIONAL, -- Need R | |
| bwp-Id | BWP-Id |
| OPTIONAL, -- Cond CSI-RS-Indicated | |
| referenceSignal | CHOICE { |
| csi-rs | NZP-CSI-RS- |
| ResourceId, | |
| ssb | SSB-Index |
| }, | |
| qcl-Type | ENUMERATED |

{typeA, typeB, typeC, typeD},
...
}

### <HARQ-ACK Feedback Transmission Method and Device>

The NR system adopts a hybrid automatic repeat request (HARQ) scheme for retransmitting corresponding data in the physical layer when a decoding failure occurs in initial transmission. In the HARQ scheme, when the receiver fails to accurately decode data, the receiver may transmit information notifying the decoding failure (negative acknowledgement (NACK)) to the transmitter, so that the transmitter can retransmit the corresponding data in the physical layer. The receiver may combine the data retransmitted by the transmitter with the data for which decoding has previously failed, thereby increasing data reception performance. In addition, when the receiver accurately decodes data, the receiver may transmit information notifying a decoding success (acknowledgement (ACK)) to the transmitter, so that the transmitter can transmit new data.

Next, the disclosure describes a method and apparatus for transmitting HARQ-ACK feedback in response to downlink data transmission. Specifically, a description is given of a method for composing HARQ-ACK feedback bits when the UE intends to transmit multiple HARQ-ACKs in one slot in the uplink.

In the wireless communication system, especially in the New Radio (NR) system, the base station may configure one component carrier (CC) or multiple CCs to the UE for downlink transmission. In addition, downlink and uplink transmission slots and symbols may be configured in each CC. When the physical downlink shared channel (PDSCH) being downlink data is scheduled, at least one of timing information of a slot to which the PDSCH is mapped, information on a position of a start symbol to which the PDSCH is mapped in the corresponding slot, or information on the number of symbols to which the PDSCH is mapped may be transmitted via a specific bit field of the downlink control information (DCI). For example, when a DCI is transmitted in slot n to schedule the PDSCH, if K0 being slot timing information for transmitting the PDSCH is 0, the start symbol position is 0, and the symbol length is 7, the corresponding PDSCH may be mapped to 7 symbols starting from symbol 0 of slot n for transmission. Meanwhile, HARQ-ACK feedback is transmitted from the UE to the base station after K1 slots from the transmission of PDSCH being a downlink data signal. K1 information being timing information for HARQ-ACK transmission may be delivered via the DCI; a set of available candidate K1 values may be transmitted through higher signaling, and one of them may be determined by the DCI.

When the UE is configured with a semi-static HARQ-ACK codebook, the UE may determine the feedback bits (or, HARQ-ACK codebook size) to be transmitted according to the table including K0 being information about a slot to which the PDSCH is mapped, information about the start symbol, information about the number of symbols or length, and candidate K1 values being HARQ-ACK feedback timing information for the PDSCH. The table including slot information to which the PDSCH is mapped, start symbol information, number of symbols or length information may follow the default values or may also configured by the base station to the UE.

When the UE is configured with a dynamic HARQ-ACK codebook, the terminal may determine the HARQ-ACK feedback bits (or, HARQ-ACK codebook size) to be transmitted in the slot in which the HARQ-ACK information is transmitted according to the K0 value being information on a slot to which the PDSCH is mapped, the K1 value being HARQ-ACK feedback timing information as to the PDSCH, and DAI (downlink assignment indicator) information included in the DCI.

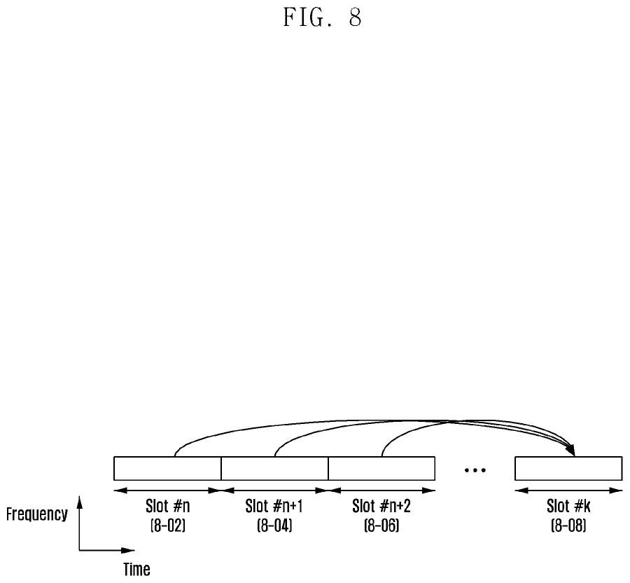

FIG. 8 is a diagram illustrating a method for configuring a semi-static HARQ-ACK codebook in the NR system.

In a situation where the number of HARQ-ACK PUCCHs that the UE may transmit in a slot is limited to one, when the UE receives a higher layer signal that configures a semi-static HARQ-ACK codebook, the UE may report HARQ-ACK information about PDSCH reception or SPS PDSCH release in the HARQ-ACK codebook in a slot indicated by the value of a PDSCH-to-HARQ_feedback timing indicator field included in DCI format 1_0 or DCI format 1_1. The UE may report a HARQ-ACK information bit value of NACK in the HARQ-ACK codebook in a slot not indicated by the PDSCH-to-HARQ_feedback timing indicator field in DCI format 1_0 or DCI format 1_1. If the UE reports HARQ-ACK information only for one SPS PDSCH release or one PDSCH reception in M_{A,c} occasions for candidate PDSCH receptions, and if the reporting is scheduled in the Pcell by DCI format 1_0 including information for which the counter DAI field is set to 1, the UE may determine one HARQ-ACK codebook for the corresponding SPS PDSCH release or corresponding PDSCH reception.

In other cases, the following HARQ-ACK codebook determination method may be followed.

When the set of occasions for candidate PDSCH receptions in serving cell c is referred to as M_{A,c}, M_{A,c} can be obtained through steps of pseudo-code 1 below.

### [Start of Pseudo-Code 1]

Step 1: initialize j to 0, and initialize M_{A,c} to an empty set. Initialize k, HARQ-ACK transmission timing index, to 0.
Step 2: set R to the set of rows of the table including information about a slot to which the PDSCH is mapped, information about the start symbol, information about the number of symbols or length. If the PDSCH-capable mapping symbol indicated by each value of R is configured as UL symbol according to the DL/UL configuration configured by a higher layer, the corresponding row is removed from R.
Step 3-1: if the UE may receive one unicast PDSCH in one slot, and if R is not empty, increment the set M_{A, c} by 1.
Step 3-2: if the UE may receive more than one unicast PDSCH in one slot, the number of PDSCHs that can be allocated to different symbols in calculated R is counted and the corresponding number is added to M_{A, c}.
Step 4: increment k by 1, and start again from step 2.

### [End of Pseudo-Code 1]

To explain pseudo-code 1 described above with reference to FIG. 8, to perform HARQ-ACK PUCCH transmission in slot #k (8-08), the UE may consider all slot candidates that may satisfy the PDSCH-to-HARQ-ACK timing indicating slot #k (8-08). In FIG. 8, it is assumed that HARQ-ACK transmission is possible in slot #k (8-08) only for PDSCHs scheduled in slot #n (8-02), slot #n+1 (8-04), and slot #n+2 (8-06) according to the PDSCH-to-HARQ-ACK timing combination. Then, based on the time domain resource configuration information for the PDSCHs schedulable in slots 8-02, 8-04 and 8-06 and the information indicating whether symbols in the slot are downlink or uplink, the maximum number of PDSCHs schedulable in each slot can be derived. For example, if two PDSCHs may be scheduled in slot 8-02, three PDSCHs in slot 8-04, and two PDSCHs in slot 8-06, the maximum number of PDSCHs included in the HARQ-ACK codebook transmitted in slot 8-08 is 7 in total. This is called the cardinality of the HARQ-ACK codebook.

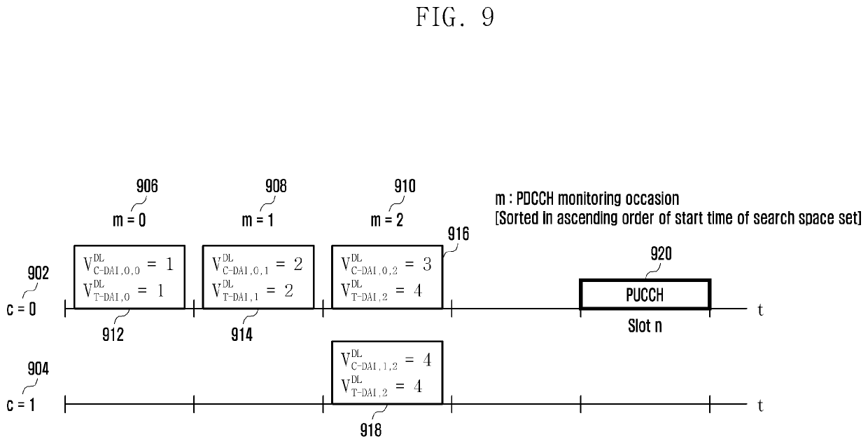

FIG. 9 is a diagram illustrating a method for configuring a dynamic HARQ-ACK codebook in the NR system.

Based on the PDSCH-to-HARQ_feedback timing value for PUCCH transmission of HARQ-ACK information for PDSCH reception or SPS PDSCH release and K0 being transmission slot location information of the PDSCH scheduled in DCI format 1_0 or 1_1, the UE may transmit HARQ-ACK information over one PUCCH transmitted in corresponding slot n.

Specifically, to transmit the HARQ-ACK information described above, the UE may determine the HARQ-ACK codebook for the PUCCH to be transmitted in the slot determined by the PDSCH-to-HARQ_feedback timing and K0 based on the DAI included in the DCI indicating the PDSCH or SPS PDSCH release.

The DAI is composed of counter DAI and total DAI. Counter DAI is information that indicates the location of HARQ-ACK information corresponding to the PDSCH scheduled in DCI format 1_0 or DCI format 1_1 in the HARQ-ACK codebook. Specifically, the value of counter DAI in DCI format 1_0 or 1_1 indicates the accumulated value of PDSCH receptions or SPS PDSCH releases scheduled by DCI format 1_0 or DCI format 1_1 in a specific cell c. The above accumulated value is set with respect to the PDCCH monitoring occasion where the scheduled DCI is present and the serving cell.

Total DAI is a value that indicates the size of the HARQ-ACK codebook. Specifically, the value of total DAI indicates the total number of previously scheduled PDSCHs or SPS PDSCH releases up to the time when the DCI is scheduled (PDCCH monitoring occasion). Also, total DAI is a parameter used in a carrier aggregation (CA) situation where HARQ-ACK information from serving cell c also includes HARQ-ACK information for PDSCHs scheduled in other cells including serving cell c. In other words, the total DAI parameter is not used in a system that operates with a single cell.

FIG. 9 is a diagram illustrating an example of the operation of the UE in relation to the DAI when a dynamic HARQ-ACK codebook is used. In FIG. 9, in a case where the UE is configured with two carriers c, when transmitting the HARQ-ACK codebook selected based on the DAI over the PUCCH 920 in the nth slot of carrier 0 (902), the changes in the values of counter DAI (C-DAI) and total DAI (T-DAI) indicated by the DCI detected in each PDCCH monitoring occasion set for each carrier are shown. First, in the DCI detected at PDCCH monitoring occasion m=0 (906), C-DAI and T-DAI each indicate a value of 1 (912). In the DCI detected at m=1 (908), C-DAI and T-DAI each indicate a value of 2 (914). In the DCI detected at m=2 (910) on carrier 0 (c=0, 902), C-DAI indicates a value of 3 (916). In the DCI detected at m=2 (910) on carrier 1 (c=1, 904), C-DAI indicates a value of 4 (918). At this time, if carriers 0 and 1 are scheduled in the same monitoring occasion, both T-DAIs indicate a value of 4.

In FIG. 8 and FIG. 9, the HARQ-ACK codebook determination may operate under the assumption that only one PUCCH containing HARQ-ACK information is transmitted in one slot. As an example of how one PUCCH transmission resource is determined within one slot, when PDSCHs scheduled by different DCIs are multiplexed and transmitted within the same slot as one HARQ-ACK codebook, the PUCCH resource selected for HARQ-ACK transmission may be determined to be the PUCCH resource indicated by the PUCCH resource field of the DCI that schedules the PDSCH most recently. That is, the PUCCH resource indicated by the PUCCH resource field in the DCI scheduled prior to that DCI is ignored.

### <Method and Device for Canceling Uplink Transmission>

In the NR system, to improve the safety and speed of URLLC when eMBB traffic and URLLC traffic coexist, a method for canceling eMBB uplink data transmission or SRS transmission is introduced. If the UE is configured with UplinkCancellation via higher layer signaling, the UE may be provided with search information and CCE aggregation level information that enables monitoring of DCI format 2_4 being UE-common DCI scrambled with ci-RNTI in one or multiple cells. Additionally, the UE may be provided with the location of the information required in the UE-common DCI through higher layer signaling, and the time-frequency region where uplink transmission is canceled. If a PUSCH or SRS overlaps with the indicated uplink transmission cancellation region by at least one symbol, the UE may not transmit the PUSCH or SRS.

### <HARQ-ACK Delay Method and Device for SPS PDSCH>

In URLLC of the NR system, when the HARQ-ACK for the SPS PDSCH is canceled due to overlapping with transmission of downlink symbols or SSB, a method of deferring the transmission of HARQ-ACK information for it has been introduced. If the UE is configured with spsHARQdeferral via higher layer signaling and the following conditions are satisfied, a new PUCCH resource may be determined for HARQ-ACK information as to SPS PDSCH reception included in the existing PUCCH resource.
The existing PUCCH resource is configured via SPS-PUCCH-AN-List or is provided via n1PUCCH-AN when SPS-PUCCH-AN-List is not configured,
It overlaps with a PUSCH or PUCCH with higher priority but is not cancelled, or
It overlaps with the downlink TDD pattern or SSB or CORESET #0

In this case, the UE may perform an operation of transmitting HARQ-ACK information having been included in the existing PUCCH on a new PUCCH or PUSCH after determining multiplexing of PUCCH and PUSCH in the most recent uplink slot.

### <Method and Device for HARQ-ACK Codebook Retransmission>

In URLLC of the NR system, when a PUCCH or PUSCH including HARQ-ACK information is dropped due to uplink signals with higher priority, a method of retransmitting only the dropped HARQ-ACK information instead of starting from PDSCH retransmission has been introduced.

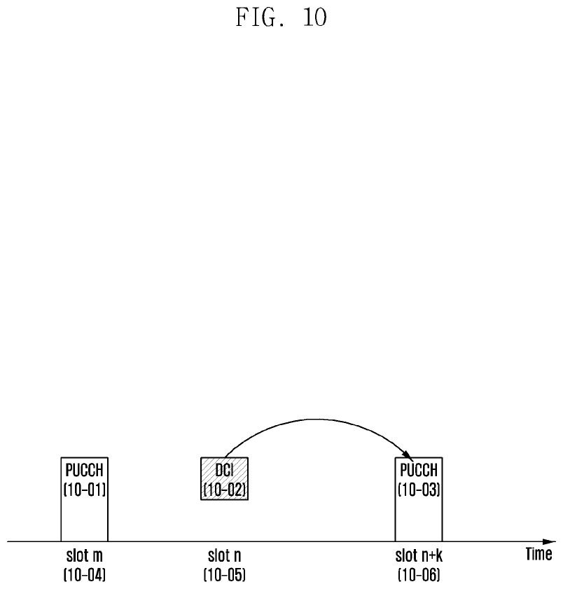

FIG. 10 is a diagram illustrating a method for configuring HARQ-ACK codebook retransmission in the NR system.

In FIG. 10, it is assumed that transmission of the PUCCH 10-01 including type-1 codebook or type-2 codebook in slot m (10-04) has been dropped due to an uplink signal having a higher priority. For retransmission of the HARQ-ACK information included in the dropped PUCCH 10-01, the UE may be instructed by the base station to receive a DCI format 10-02 having a CRC scrambled with C-RNTI or MCS-RNTI and not scheduling a PDSCH. If the last slot of the PDCCH including the above DCI format is slot n (10-05), the DCI format may instruct the UE to transmit a PUCCH including the HARQ-ACK codebook included in the previous PUCCH 10-01 in slot n+k (10-06). Here, slot n+k is located after slot m.

If the value of pdsch-HARQ-ACK-retx or pdsch-HARQ-ACK-retxDCI-1-2 field included in DCI format 1_1 or 1_2 is ‘l’, the UE may make the following determination on m of slot m.

$$- m = n - 1$$

l has a value between −7 and 24
l may be determined by 1:1 mapping in ascending order among the MCS fields of DCI format 1_1 or DCI format 1_2.

Additionally, the UE may multiplex a HARQ-ACK codebook different from the existing HARQ-ACK codebook on the PUCCH transmitted in slot n+k. The multiplexing operation may follow the existing HARQ-ACK codebook multiplexing operation.

### <TDD UL-DL Pattern and SFI>

In the 5G communication system, the downlink signal transmission section and the uplink signal transmission section may be dynamically changed. To this end, the base station may indicate to the UE whether each of OFDM symbols constituting one slot is a downlink symbol, an uplink symbol, or a flexible symbol through the slot format indicator (SFI). Here, a flexible symbol may refer to a symbol that is neither a downlink symbol nor an uplink symbol, or a symbol that can be switched into a downlink or uplink symbol according to UE-specific control information or scheduling information. At this time, a flexible symbol may include a gap guard required during the process of switching from downlink to uplink.

The UE having received the slot format indicator may receive a downlink signal from the base station at the symbol indicated as a downlink symbol, and transmit an uplink signal to the base station at the symbol indicated as an uplink symbol. At the symbol indicated as a flexible symbol, the UE may perform at least a PDCCH monitoring operation, and through another indicator such as a DCI, the UE may receive a downlink signal from the base station at the flexible symbol (e.g., when receiving DCI format 1_0 or 1_1), or transmit an uplink signal to the base station (e.g., when receiving DCI format 0_0 or 0_1).

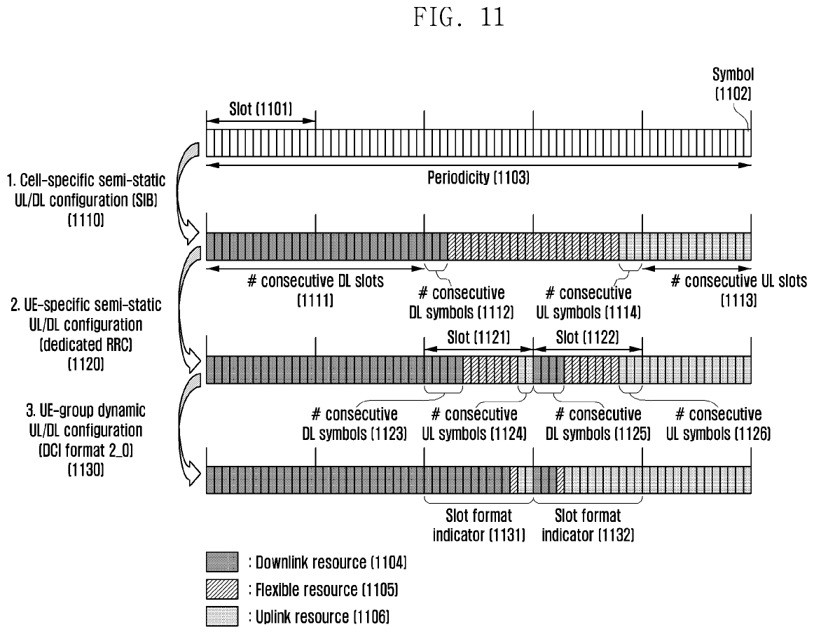

FIG. 11 is a diagram illustrating an example of uplink/downlink configuration (UL/DL configuration) in the 5G system, where three stages of uplink/downlink configuration of symbols/slots are illustrated.

With reference to FIG. 11, in the first stage, cell-specific configuration information 1110 for semi-statically configuring uplink-downlink may be configured. For example, the uplink-downlink of symbols/slots may be configured through system information such as SIB. Specifically, the cell-specific uplink-downlink configuration information 1110 of the system information may include uplink-downlink pattern information and information indicating a reference subcarrier spacing. The uplink-downlink pattern information may indicate a transmission periodicity (1103) of each pattern, the number of consecutive full DL slots at the beginning of each DL-UL pattern (1111), the number of consecutive DL symbols in the beginning of the slot following the last full DL slot (1112), the number of consecutive full UL slots at the end of each DL-UL pattern (1113), and the number of consecutive UL symbols in the end of the slot preceding the first full UL slot (1114). At this time, the UE may determine a slot/symbol that is not indicated as uplink or downlink as a flexible slot/symbol.

In the second stage, UE-specific configuration information 1120 transmitted via UE-dedicated higher layer signaling (i.e., RRC signaling) may indicate symbols to be set as downlink or uplink within a flexible slot or a slot (1121 or 1122) containing flexible symbols. For example, the UE-specific uplink-downlink configuration information 1120 may include a slot index indicating a slot (1121 or 1122) containing a flexible symbol, the number of consecutive downlink symbols in the beginning of the slot (1123 or 1125), and the number of consecutive uplink symbols in the end of the slot (1124 or 1126), or may include information indicating full downlink or information indicating full uplink for the slot. In this case, the symbol/slot set as uplink or downlink through the cell-specific configuration information 1110 in the first stage cannot be changed to downlink or uplink through UE-dedicated higher layer signaling (1120).

Finally in the third stage, to dynamically change the downlink signal transmission section and the uplink signal transmission section, the downlink control information of the downlink control channel may include a slot format indicator 1130 that indicates whether each symbol in a slot among multiple slots starting from the slot in which the downlink control information is detected is a downlink symbol, an uplink symbol, or a flexible symbol. At this time, for the symbol/slot set as uplink or downlink in the first and second stages, the slot format indicator cannot indicate that it is downlink or uplink. The slot format of the slot (1131 or 1132) including at least one symbol not set as uplink or downlink in the first and second stages may be indicated by the corresponding downlink control information. The slot format indicator may indicate the uplink-downlink configuration for 14 symbols in one slot as shown in Table 18 below. The slot format indicator may be transmitted to multiple UEs simultaneously through a UE group (or cell) common control channel. In other words, the downlink control information including a slot format indicator may be transmitted via the PDCCH having a CRC scrambled with an identifier (e.g., SFI-RNTI) other than the UE-specific C-RNTI (cell-RNTI). The downlink control information may include a slot format indicator for one or more slots, i.e., N slots. Here, the value of N may be an integer greater than 0, or a value set by the UE through higher layer signaling from the base station among a set of possible values defined in advance, such as 1, 2, 5, 10 and 20. The size of the slot format indicator may be configured by the base station to the UE through higher layer signaling. Table 18 is a table describing the SFI contents.

TABLE 18

| | Symbol number (or index) in one slot | | | | | | | | | | | | | |
|---|---|---|---|---|---|---|---|---|---|---|---|---|---|---|
| Format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |

. . .

| | | | | | | | | | | | | | | |
|---|---|---|---|---|---|---|---|---|---|---|---|---|---|---|
| 9 | F | F | F | F | F | F | F | F | F | F | F | F | U | U |

. . .

| | | | | | | | | | | | | | | |
|---|---|---|---|---|---|---|---|---|---|---|---|---|---|---|
| 19 | D | F | F | F | F | F | F | F | F | F | F | F | F | U |

. . .

| | | | | | | | | | | | | | | |
|---|---|---|---|---|---|---|---|---|---|---|---|---|---|---|
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines the slot format for the slot based on tdd-UL-DL- |
| | ConfigurationCommon, or tdd-UL-DL-ConfigurationDedicated and, |
| | if any, on detected DCI formats |

In Table 18, D indicates a downlink symbol, U indicates an uplink symbol, and F indicates a flexible symbol. According to Table 18, the total number of slot formats that can be supported for one slot is 256. The maximum size of information bits that can be used for slot format indication in the NR system is 128 bits, and may be configured by the base station to the UE through higher layer signaling, for example, ‘dci-PayloadSize’.

Hereinafter, embodiments of the disclosure will be described in detail with reference to the attached drawings. In the following description, the base station is a main agent that allocates resources to UEs, and may be at least one of gNode B, gNB, eNode B, Node B, BS, wireless access unit, wireless access point, base station controller, or node on the network. The terminal may be a UE (user equipment), an MS (mobile station), a cellular phone, a smartphone, a computer, or a multimedia system capable of performing a communication function. In the following description, the embodiments of the disclosure will be described by using the 5G system as an example, but the embodiments of the disclosure may be applied to other communication systems having similar technical backgrounds or channel configurations. For example, LTE or LTE-A mobile communication and mobile communication technology to be developed after 5G may be included here. Therefore, those skilled in the art may understand that the embodiments of the disclosure can be applied to other communication systems with some modifications within the scope of the disclosure. The contents of the disclosure can be applied to frequency division duplex (FDD), time division duplex (TDD), and cross division duplex (XDD) systems.

Additionally, in describing the disclosure, if it is judged that a detailed description of a related function or configuration may unnecessarily obscure the gist of the disclosure, the detailed description will be omitted. Further, those terms described below are terms defined in consideration of their functions in this disclosure, and may vary depending on the user, the intention of the operator, or the custom. Hence, their meanings should be determined based on the contents throughout this specification.

In describing the disclosure below, higher layer signaling may be signaling corresponding to at least one of the following signalings or a combination thereof.
MIB (master information block)
SIB (system information block) or SIB X (X=1, 2, . . . )
RRC (radio resource control)
MAC (medium access control) CE (control element)

Additionally, L1 signaling may be signaling corresponding to at least one or a combination among signaling methods using the following physical layer channels or signalings.
PDCCH (physical downlink control channel)
DCI (downlink control information)
UE-specific DCI
Group common DCI
Common DCI
Scheduling DCI (e.g., DCI used for scheduling downlink or uplink data)
Non-scheduling DCI (e.g., DCI not intended for scheduling downlink or uplink data)
PUCCH (physical uplink control channel)
UCI (uplink control information)

In the following description of the disclosure, the above examples are described through a number of embodiments, but they are not independent and one or more embodiments may be applied simultaneously or in combination.

### Embodiment 1: Overview of Network-Controlled Repeater

Coverage is a very important factor in wireless communication systems. Currently, 5G is commercialized, and millimeter waves are also included in the commercialization, but actual usage is not much due to limited coverage. Many operators are looking for ways to provide stable coverage while also being economical. One option is to install many base stations, but the high cost has led to a search for more economical schemes.

For this reason, the first technology considered is Integrated Access and Backhaul (IAB), which has been studied across Rel-16 and Rel-17. IAB is a type of relay that does not require a wired backhaul network and relays between the base station and the UE. IAB has similar performance to the base station, but has the corresponding disadvantage of increased cost.

Second, the existing RF repeater may be considered. The RF repeater is a repeater of the most basic unit that performs the operation of amplifying and forwarding an incoming signal. RF repeaters have the advantage of being cheap because they simply perform the operation of amplifying and forwarding, but they cannot actively respond to various situations. For example, RF repeaters generally do not use directional antennas, but rather omni-antennas, so they cannot obtain beamforming gain. In addition, even when there is no UE connected to the RF repeater, the RF repeater may amplify and forward noise, so it may be a source of interference.

IAB nodes and RF repeaters have clear advantages and disadvantages because they are biased towards one side between performance and cost. To realistically increase coverage, not only performance but also cost must be considered, which is creating a need for new terminals or amplifiers.

In relation to 3GPP Rel-18, research is underway on a network-controlled repeater (NCR) that maintains the simple amplification and forwarding operation of the RF repeater and maximizes coverage enhancement by enabling beamforming technology with adaptive antennas. In order for the NCR to transmit signals to the UE by using adaptive antennas in the cell, it should be able to receive control signals from the base station. Therefore, the NCR should be able to detect and decode a control signal of the base station, and it may have a transmission and reception structure for control signals similar to that of the UE.

Basically, the NCR may amplify a signal received from the base station and forward it to the UE, and may amplify a signal received from the UE and forward it to the base station. That is, the NCR does not detect or decode the signal or channel transmitted and received by the base station and the UE, but only amplifies and forwards it. Hence, the UE cannot know whether an NCR is involved in the communication between the base station and the UE. In other words, from the UE's perspective, the base station and the NCR cannot be distinguished, and the NCR may appear as a base station. Since the UE does not need any additional information or operation for the NCR, the NCR can be supported for UEs of any release. That is, the NCR can be supported not only for UEs supporting 3GPP Rel-18, but also for UEs supporting later releases or earlier releases.

As described above, from the base station's perspective, the NCR may be seen as a normal UE. When the NCR is first installed, it may perform initial access to the base station like a normal UE, and after the higher layer connection (e.g., RRC connection) is established, the NCR may receive configurations that a normal UE can receive from the base station. The NCR may perform the amplification and forwarding operation after establishment of a connection to the base station.

From the base station's perspective, it is necessary to know whether a UE is directly connected to the base station or connected through an NCR. When a UE is within the coverage of an NCR, the UE may communicate with the base station through the NCR, and the base station may recognize this based on implementation.

The base station may know which UE is communicating through which NCR, but the NCR cannot know this fact. From the NCR's perspective, the NCR may perform the operation of amplifying a signal and forwarding it to the UE under the control of the base station, regardless of whether the UE is in its coverage or not. In order for the base station to control an NCR, a control signal that plays a similar role to the DCI may be required. In this disclosure, for convenience, this control signal is defined/named as side control information (SCI). SCI is not limited to those terms described later in this disclosure, and other terms having equivalent technical meanings such as repeater-DCI (R-DCI), repeater control information (RCI), or network-controlled repeater control information (NCI) may be used. Alternatively, a DCI format may be stipulated/introduced for the role of the SCI of the disclosure. The physical channel through which the SCI is transmitted and received may be, for example, the PDCCH, but without being limited thereto, other terms/names/channels may be used. The SCI may mean a control channel transmitted by the base station to control the NCR, or control information transmitted and received on such a control channel. The SCI is a signal that is unknown to the UE, and can only be recognized by the base station and the NCR.

That is, the SCI can be used between the base station and the NCR.

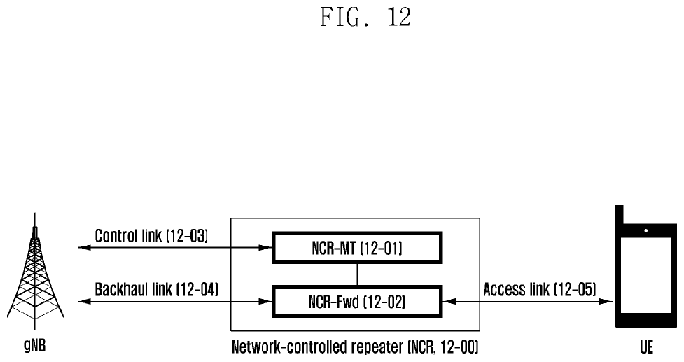

FIG. 12 illustrates an example of transmission and reception associated with the NCR when the NCR relays between the base station and the UE according to an embodiment of the disclosure.

In FIG. 12, an example of an operation in which an NCR 12-00 relays communication (e.g., downlink, uplink) between the base station and the UE is illustrated. The NCR requires a structure that can transmit and receive control signaling to and from the base station, which may be performed by the network-controlled repeater-mobile termination (NCR-MT) 12-01. That is, the NCR may transmit and receive control signaling to and from the base station through the NCR-MT. The NCR-MT may receive control signaling and transmit feedback through the control link (C-link) 12-03. That is, from the base station's perspective, the NCR-MT appears as a normal UE and may perform communication accordingly. The base station may transmit control signaling to the NCR-MT to control the network-controlled repeater-forwarding (NCR-Fwd) 12-02.

The NCR-Fwd may be composed of only basic RF or physical layer and may perform an operation of amplifying a signal and forwarding it to the UE. In the downlink, the NCR-Fwd may perform an operation of receiving a signal from the base station through a backhaul link 12-04 and then forwarding it to the UE through an access link 12-05. At this time, since the backhaul link and the C-link are not necessarily physically separate links, the NCR may detect the SCI, which is configured by the base station to instruct the operation of the NCR, on the C-link, while amplifying the downlink signal from the base station and forwarding it to the UE at the same time.

In the uplink, the NCR may receive an uplink signal transmitted by the UE through the access link 12-05, and amplify the uplink signal and forward it to the base station through the backhaul link 12-04. At this time, the NCR may transmit uplink feedback or SRS for the SCI or higher layer control to the base station. Assuming that the NCR-MT part of the NCR is the same as a normal UE, it would be a reasonable assumption that the NCR transmits uplink feedback by itself.

As described above, in the downlink, the NCR may detect the SCI, and amplify a downlink signal and forward it to the UE at the same time. This operation may be enabled in case that the NCR can perform the amplification and forwarding operation while searching for the SCI simultaneously. Since searching for the SCI requires low complexity, the NCR will be able to perform the above operation without additional cost. On the other hand, in the uplink, the operation of the NCR for transmitting uplink feedback by itself while simultaneously amplifying and forwarding the uplink signal of the UE may be varied depending on the implementation of the NCR.

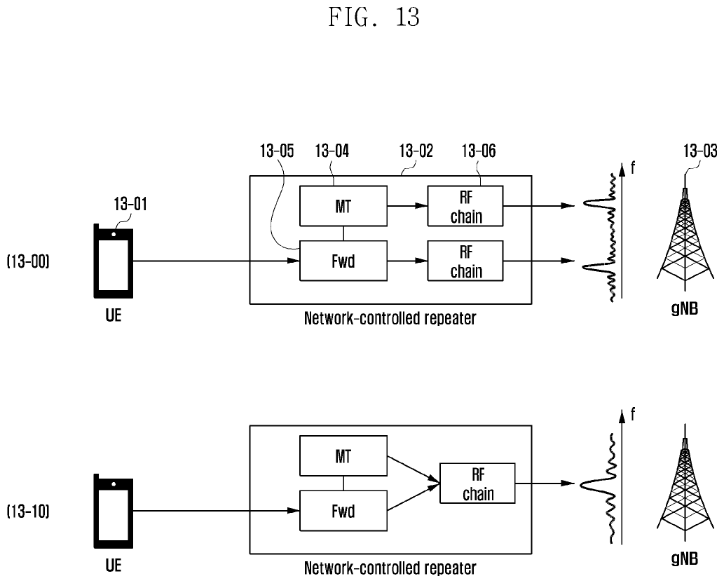

FIG. 13 illustrates an example of uplink transmission along an RF chain when the NCR relays between the base station and the UE according to an embodiment of the disclosure.

With reference to FIG. 13, the UE 13-01 may transmit an uplink signal to the base station 13-03 through the relay of the NCR 13-02. Part 13-00 of FIG. 13 illustrates a situation where the NCR-MT 13-04 and the NCR-Fwd 13-05 are connected to different RF chains 13-06. Part 13-10 of FIG. 13 illustrates a situation where the NCR-MT and the NCR-Fwd are connected to the same RF chain.

The RF chain may be a functional configuration in which a single radio link and a series of RF processing elements (e.g., antenna, power amplifier, mixer) are connected like a chain. In the RF chain, the signal is converted into an analog signal usually at the digital end, the frequency is increased, and the resulting signal is passed through several filters. Usually, one RF chain is used for one stream. Therefore, in part 13-00, the signal from the UE and the signal from the NCR-MT are transmitted in the uplink to the base station through different RF chains, so they can be transmitted on different frequency domains within the same time. On the other hand, in part 13-10, if the signal transmitted by the UE and the signal transmitted by the NCR-MT are viewed as different streams, they cannot be transmitted simultaneously through the same RF chain.

The NCR may perform the operation of signal amplification and forwarding under the control of the base station by utilizing the NCR-MT and NCR-Fwd structure described above. Since amplification and forwarding amplifies the configured bandwidth as it is, noise may also be amplified and forwarded.

For example, when multiple NCRs perform transmission to the base station in the uplink, the signal-to-noise ratio (SNR) of the base station will deteriorate due to an increase in the noise floor of the base station. In addition, due to the nature of NCR pursuing low prices, there is a possibility that the filter performance may be not good, which may lead to a high adjacent channel leakage ratio (ACLR).

Because of the above drawbacks, it would be beneficial for the overall system to turn off the amplification and forwarding function when there is no UE served by the NCR. Hence, signaling for controlling the on/off of the NCR-Fwd is required to reduce the overall system interference.

### Embodiment 2: Dynamic On/Off Signaling for Network-Controlled Repeater

In the second embodiment of the disclosure, a description is given of a method in which the NCR dynamically receives signaling from the base station to turn on and off the operation of the NCR-Fwd.

In the disclosure, unless specifically stated otherwise, the NCR being in an on state may mean the NCR-Fwd being in an on state, and the NCR being in an off state may mean the NCR-Fwd being in an off state. At least a portion of the second embodiment of the disclosure may be applied in combination with at least a portion of the first embodiment.

In the disclosure, unless specifically stated otherwise, performing the on/off operation in units of frequency resource/cell/panel may mean that the operation of the NCR-Fwd is turned on/off in units of frequency resource/cell/panel. For example, the NCR-Fwd may perform signal amplification and forwarding operation in an on state for a specific frequency resource/cell/panel, and may not perform signal amplification and forwarding operation in an off state for a specific frequency/resource/cell.

The on/off of the operation of the NCR-Fwd means turning on/off the amplification and forwarding operation. The NCR may detect control signaling from the base station through the NCR-MT even when the operation of the NCR-Fwd is turned off. At this time, it is assumed that the base station determines whether the NCR is turned on or off based on the presence or absence of a UE served by the NCR. For example, the NCR serving at least one UE may remain in the on state (or, may be determined to maintain the on state), and conversely, the NCR not serving any UE may remain in the off state (or, may be determined to maintain the off state). Dynamic on/off signaling for the NCR may be configured via higher layer signaling (e.g., RRC), and may be indicated by DCI-based SCI. That is, the NCR may receive configuration information for dynamic on/off signaling through higher layer signaling. In addition, the NCR may receive indication information through control information.

In the following description of the disclosure, for convenience of explanation, the higher layer signaling for NCR on/off is referred to as “NCR-onoffConfig”. However, the disclosure is not limited to those terms described below, and other terms having equivalent technical meanings may be used.

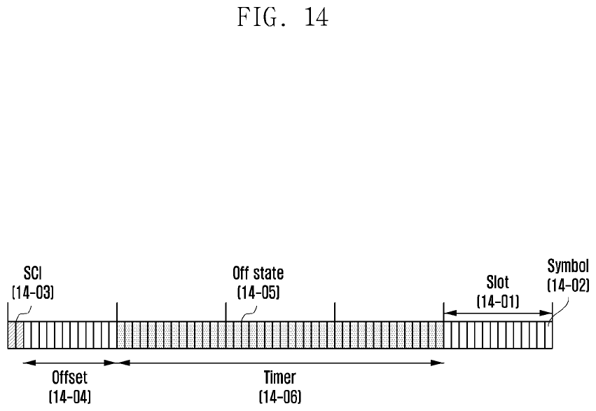

FIG. 14 illustrates an example of dynamic on-off signaling for the NCR according to an embodiment of the disclosure.

FIG. 14 illustrates a case where one slot 14-01 is composed of 14 symbols 14-02, and the SCI 14-03 indicates an off state (14-05) over 4 slots. This is an illustration and the disclosure is not limited thereto. For example, the number of symbols/slots may vary, and the SCI 14-03 may indicate an on state.

The NCR may be configured by the base station with NCR-onoffConfig being higher layer signaling for on/off. NCR-onoffConfig may be configuration information for dynamic on/off signaling described above. More specifically, NCR-onoffConfig may include, but not limited to, the following configuration information. NCR-onoffConfig may include at least some of the following configuration information. Additionally, the terms described below are not restrictive, and other terms having equivalent technical meanings may be used.
Offset 14-04: the NCR may detect the SCI indicating on/off and be configured with a time domain offset required for switching to the on or off state. If the offset is set in slot units, for example, kth slot (or, k slots), the NCR may switch to the indicated state (i.e., on or off) at the first symbol of slot n+k when the SCI is detected in slot n. If the offset is set in symbol units, for example, kth symbol (or, k symbols), the NCR may switch to the indicated state (i.e., on or off) at the kth symbol after the last symbol where the SCI is detected. If the offset is not configured, a default value may be expected to be set (or applied).
Timer 14-06: the NCR does not remain indefinitely in the on or off state as indicated by the SCI, but may return to the default state after the time set to the timer expires. Here, the timer may be set in slot units or time units (e.g., ms), and the default state may be the on or off state. If the timer is not set, a default value may be expected to be set (or, applied).
Time information: the NCR may be configured with information about the duration or pattern of the on or off state.
   If the number of consecutive slots or the list for SLIV (start symbol and number of consecutive symbols, S and L indicator value) is set in the time information, the NCR may apply method 2-1 described below.
   If the number of consecutive slots is set in the time information, the NCR may apply method 2-2 described below.
   If the time information includes a TDD (time domain duplex) configuration list, the NCR may apply method 2-3 described below. The TDD configuration list includes a number of TDD configurations including the off state and combinations thereof.
   If the time information is not configured, the NCR expects the duration for the on or off state to be the same as the timer, and does not expect any indication for the pattern.
Direction: the NCR may be provided with information indicating whether the instructed on or off state is applied to the uplink or the downlink. For example, if configured as uplink, the indicated state may be applied only to the uplink symbol or slot, and the indicated state may be not applied to the downlink symbol or slot. If configured as applying to uplink, the NCR may identify that on or off is indicated for the uplink symbol or slot when it receives dynamic on/off signaling. If configured as applying to downlink, the NCR may identify that on or off is indicated for the downlink symbol or slot when it receives dynamic on/off signaling. An embodiment as to the direction may be not applied to method 2-3 described below. If the direction is not set, on/off is applied regardless of uplink or downlink.
Cell index list: if the NCR reports to the base station a capability of performing amplification and forwarding on multiple carriers and independently controlling each carrier, the NCR may be configured with a cell index list. If the NCR does not report or does not have the above capability, the NCR is not provided with a cell index list or does not expect any operation related to the cell index list even if it is provided. The cell index list may include one or multiple cell indices. If the cell index list is not configured, the on or off state indicated by the SCI may always be applied to all carriers. For example, the NCR may apply an on or off state to a cell corresponding to an index indicated by the SCI among the indices included in the cell index list. A cell index list according to an embodiment may be understood as an example of an index list for the frequency domain or frequency resources.
Panel index list: if the NCR reports a capability of performing simultaneous amplification and forwarding using one or more panels to the base station, it may be configured with a panel index list. If the NCR does not report or does not have the above capability, the NCR is not provided with a panel index list or does not expect any operation related to the panel index list even if it is provided. The panel index list may include one or multiple panel indexes. If a panel index list is not configured, the on or off state indicated by the SCI may always be applied to all panels. For example, the NCR may apply the on or off state to a panel corresponding to an index indicated by the SCI among the indexes included in the panel index list.

If the NCR is not configured with higher layer signaling NCR-onoffConfig, the NCR does not expect to perform the on/off operation.

If NCR-onoffConfig is configured via higher layer signaling and the NCR detects the SCI transmitted on the PDCCH, the NCR may change the on or off state according to the field values of the SCI. More specifically, the SCI may include, but not limited to, the following field. Also, the terms described below are not restrictive, and other terms having equivalent technical meanings may be used.
On off state indication: the NCR may receive an on off state indication. More specifically, the NCR may be indicated in one or a combination of the following ways.
   <Method 1-1> The on or off state may be indicated with 1 bit. For example, if it is 0, the off state may be indicated, and if it is 1, the on state may be indicated. Conversely, if it is 0, the on state may be indicated, and if it is 1, the off state may be indicated. Alternatively, instead of indicating an on or off state, 1 bit may indicate a transition from the current state to the next state (i.e., if the current state is on, the next state is off, and if the current state is off, the next state is on). If the NCR has detected the on off state indication field of 1 bit, regardless of its value, the NCR may change the next state with respect to the state of the first or last symbol of the PDCCH at which the SCI is detected. That is, the NCR may change the state of the NCR-Fwd with respect to the on/off state of the NCR-Fwd at the first or last symbol of the PDCCH where the SCI is detected. For example, if the first or last symbol of the PDCCH of the SCI indicating the on or off state is on, the NCR may make a transition to the off state after the configured offset. That is, if the NCR-Fwd is on at the first or last symbol of the PDCCH of the SCI, the NCR-Fwd may transition to the off state. Conversely, if the NCR-Fwd is off at the first or last symbol of the PDCCH of the SCI, the NCR-Fwd may transition to the on state.
   <Method 1-2> If the NCR is configured with a cell index list or a panel index list via higher layer signaling, it may be assumed that the NCR can perform the on or off operation independently on each carrier (or, cell) or panel. Here, the on off state indication may correspond to a codepoint. If the NCR is configured with a cell index list via higher layer signaling, the bit size may be the same as the number of cell indexes, and each bit may correspond to one cell index. For example, if there are three indexes CC #0, CC #1, CC #3 in the cell index list, “010” may indicate {CC #0: off, CC #1: on, CC #3: off} states or {CC #0: on, CC #1: off, CC #3: on} states. If the NCR is configured with a panel index list via higher layer signaling, the bit size may be the same as the number of panel indexes, and each bit may correspond to one panel index. For example, if there are three indices panel #0, panel #1, and panel #3 in the panel index list, “010” may indicate {panel #0: off, panel #1: on, panel #3: off} states or {panel #0: on, panel #1: off, panel #3: on} states. The indications for the cell index list or the panel index list may be set by independent fields in the SCI, or may be set by a single field. If being composed of one field, X MSB (most significant bit) bits of those bits may be used in correspondence to the cell index list, and Y LSB (least significant bit) bits may be used in correspondence to the panel index list. This is an example, and conversely, X MSB bits may correspond to the panel index list, and Y LSB bits may correspond to the cell index list. If the cell index list or panel index list is not configured via higher layer signaling, but the on off state is indicated by multiple bits, the NCR may receive the indication by recognizing only the MSB or LSB among the multiple bits and ignore the other bits. The cell index according to an embodiment may be understood as an example of an index for the frequency domain or frequency resources.
Time domain indication: if time information is configured via higher layer signaling, the NCR may receive an indication of the duration of the on or off state indicated by the SCI. If the NCR detects presence of a time domain indication field in the SCI, more specifically, the NCR may be instructed in one of the following ways.
   <Method 2-1> The time domain indication field may indicate an entry in the list of consecutive slots and/or SLIVs configured via higher layer signaling. If the NCR detects at least one bit in the on off state indication field (e.g., the on off state indication field may be composed of more than one bit) and only consecutive slots are set, the NCR may maintain the state indicated by the on off state indication field over the consecutive slots. If only an SLIV is configured, the NCR may apply the on or off state to the configured SLIV of one slot. If consecutive slots and SLIV are configured together, the NCR may apply the on or off state to the same SLIV over the consecutive slots. The NCR expects that the consecutive slots will always be less than the value of the timer set via higher layer signaling.
   <Method 2-2> The time domain indication field may indicate an on off pattern as a bit map by utilizing the consecutive slots configured via higher layer signaling as a unit. For example, if 2 consecutive slots are configured and the time domain indication field is set to “0110”, the NCR may receive an indication of the state “off/off/on/on/on/on/off/off” or “on/on/off/off/off/off/on/on” for each slot. That is, if the set consecutive slot value is 2 and the time domain indication field is set to “0110”, this may be interpreted as if the time domain indication field is repeated twice as 00 11 11 00.
   <Method 2-3> The time domain indication field may indicate an entry of the TDD configuration list configured via higher layer signaling. In this case, the NCR may receive an indication of downlink/uplink/flexible symbol (D/U/F) and ‘O’ (off) state. At this time, the downlink/uplink/flexible symbol may be seen as being in the on state. For example, if the NCR receives an indication of DDOFU, the NCR performs an operation of transmitting in downlink, entering the OFF state, and then transmitting in uplink. Here, ‘O’ refers to the off state for convenience of description. However, the disclosure is not limited to those terms described below, and other terms having equivalent technical meanings may be used. The NCR does not expect that the TDD configuration indicated by the above field changes the downlink or uplink symbol set by cell-specific or higher layer signaling to uplink or downlink. The NCR may expect an operation of changing “D/F/U” to ‘O’ or changing ‘O’ to “D/F/U”.
   If the NCR does not receive timing information through higher layer signaling, the NCR does not expect a time domain indication field, it expects that the duration for the on or off state is the same as the timer, and it does not expect an indication of a pattern or TDD configuration.

The priority of the configurations and indications for the above-mentioned panel, time, and cell decreases in the order of panel, time, and cell. In other words, the priority of the panel is the highest, and then the time and the cell in that order. For example, if the panel is indicated to be off and the time and cell are indicated to be on, the NCR maintains the off state of the panel since the panel has the highest priority.

The NCR may perform amplification and forwarding operations for signals and channels important to the system even in the off state. For example, SSB, type 0 PDCCH CSS search area, channel containing the SIB, and PRACH are cell-specific signals or channels that can be configured not only for the UE but also for the NCR, so the UE and the NCR may share the same configuration. If a cell-specific system-critical signal or channel (e.g., SSB, type 0 PDCCH CSS search area, channel containing SIB, PRACH) overlaps with off-state symbols by at least one symbol, the NCR may ignore the off state of the overlapping symbol and perform an operation in the on state.

### Embodiment 3: Semi-Static On-Off Signaling for Network-Controlled Repeater

The third embodiment of the disclosure describes a configuration for semi-static on/off signaling for the NCR. At least a portion of the third embodiment of the disclosure may be applied in combination with at least a portion of the first embodiment and/or at least a portion of the second embodiment.

In order for the base station to perform on/off signaling to the NCR, it is necessary to determine whether a UE is being served by the NCR. In this disclosure, for convenience of description, the process by which the base station determines whether a UE is being served by the NCR is referred to as a UE association identification process.

Since the UE is unaware of the presence of the NCR, it will be unable to transmit feedback to the base station via additional signaling. Hence, the base station may perform UE association identification by reusing existing specifications and considering the characteristics of the NCR.

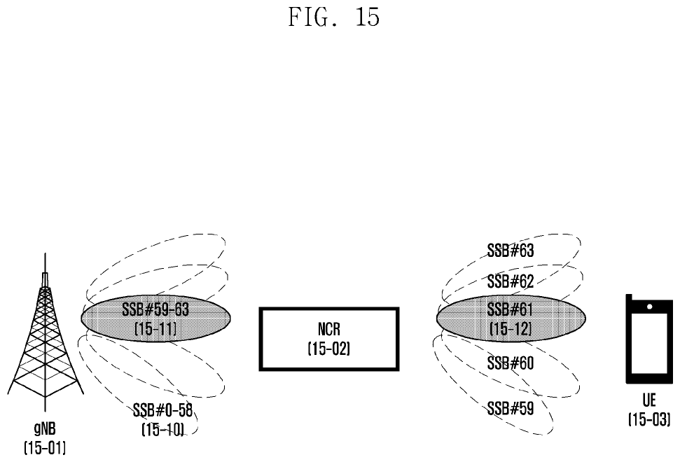

FIG. 15 illustrates an example of amplifying and forwarding the SSB by the NCR according to an embodiment of the disclosure.

For example, the base station may perform the first stage of UE association by utilizing the amplification and forwarding features of the NCR, and may make a determination in the second stage by utilizing the on/off features. More specifically, the base station may perform the UE association identification process with the NCR and the UE through the following example.
First stage: the base station may configure a cell-specific signal SSB (SS/PBCH block) to the NCR and the UE. FIG. 15 illustrates a situation where the base station 15-01 utilizes, among 64 SSBs configured to the NCR 15-02, SSBs with indexes 59 to 63 (15-11) for amplification and forwarding to the UE 15-03 without utilizing SSBs with indexes 0 to 58 (15-10) for amplification and forwarding. This configuration may be set via higher layer signaling. That is, the NCR may perform amplification and forwarding operation for the SSBs indicated by 15-11 in the backhaul link, and the UE may report the SSB block index (15-12) with the best RSRP (reference signal received power) among the amplified and forwarded SSBs in the access link. The base station may assume that the UE is served by the NCR if the SSB indicated by 15-12 belongs to the SSBs indicated by 15-11. Here, the SSBs indicated by 15-11 may be configured to the NCR via higher layer signaling. In addition, the beam related information (e.g., QCL-Type D) of the SSBs in the access link including the SSB indicated by 15-12 may be configured by the base station via higher layer signaling or may be specified through NCR implementation. For example, the base station may transmit, to the NCR, configuration information indicating amplification and forwarding of the SSBs corresponding to SSB indexes 59, 60, 61, 62, 63. The base station may obtain reporting information from the UE about the index of the block with the best RSRP among the transmitted SSBs. Here, if the SSB index reported by the UE is included in SSB indexes 59, 60, 61, 62, 63 that have been configured by the base station to the NCR for amplification and forwarding, the base station may determine that the UE is served by the NCR.
Second stage: The base station may assume that a specific UE is being served by the NCR as a result of the first stage. However, the above assumption is not always correct due to the channel characteristics of wireless communication. The reason is that even if the base station transmits SSB blocks 15-11 for amplification and forwarding to the NCR, UEs that are not served by the NCR may also receive the SSB blocks 15-11 due to reflection and diffraction. Hence, the base station needs to refine/verify once more the UE specified in the first stage. The base station may instruct the UE to transmit an aperiodic SRS associated with the SSB 15-12 or a PRACH triggered by a PDCCH order. The base station may set or instruct the NCR to set the off state at the symbol where the SRS or PRACH is transmitted by the UE. When the NCR is in the off state, amplification and forwarding operation is not performed. Based on this, the base station may make the following determination.
   If the SRS or PRACH is not detected, the UE may be determined to be served by the NCR.
   If the SRS or PRACH is detected, the UE may be determined not to be served by the NCR.
   Contrary to the above example, the base station may instruct the NCR to be off and then to be on only at a specific symbol. For example, the base station may set or instruct the NCR to set the on state at the symbol where the SRS or PRACH is transmitted by the UE. The base station may then make the following determination.
   If the SRS or PRACH is detected, the UE may be determined to be served by the NCR.
   If the SRS or PRACH is not detected, the UE may be determined not to be served by the NCR.

The above example is one of examples of UE association identification. UE association identification is an essential element for the base station to operate NCRs, and may be used not only for on/off operation to reduce interference, but also for beam management. Since the UE may enter or leave the NCR's coverage over time, the base station may have to periodically perform UE association identification to identify the serving status.

In the above example, the NCR receives signaling to perform the on/off operation.

The on/off operation of the NCR may be dynamically operated as described in the first embodiment, but it may be seen as a waste of resources to operate by receiving dynamic signaling periodically. If the base station operates multiple NCRs, periodic dynamic signaling for UE association identification may be seen as a significant overhead.

If the base station can configure the NCR to periodically perform on/off operation at a specific time, the signaling overhead will be reduced, and the UE association identification process can also be performed periodically from the system perspective. The base station may configure periodic on/off operation to the NCR and may perform the UE association identification process every period. So, semi-static on-off signaling is required for periodic UE association identification.

Methods based on semi-static on-off signaling may include a method of receiving a configuration via higher layer signaling (e.g., RRC) and indicating activation and deactivation via a MAC-CE. “NCR-onoffConfig” named in the first embodiment may be used for higher layer signaling of semi-static on/off, but the details may be or may be not shared with the dynamic signaling configuration. Unlike dynamic signaling, which can indicate on/off for each cell or panel for more flexible configuration, semi-static on/off signaling may always be applied to the entire cell or panel.

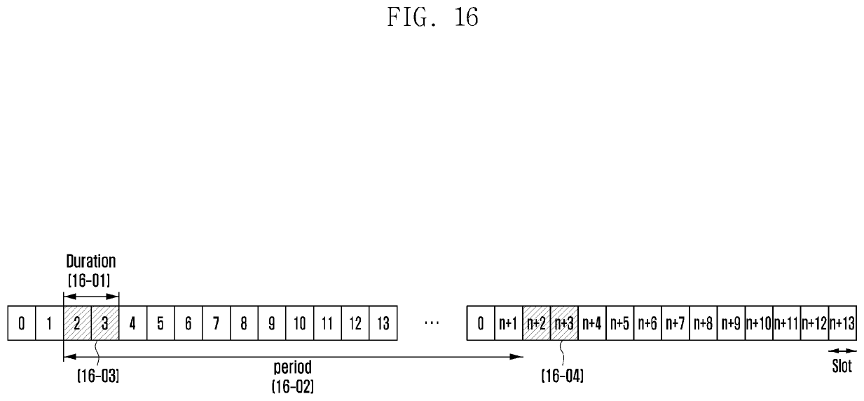

FIG. 16 illustrates an example of semi-static on-off signaling for the NCR according to an embodiment of the disclosure.

FIG. 16 illustrates the duration 16-01 and period 16-02 of a first interval 16-03, and a second interval 16-04 when semi-static on-off signaling is activated. If the NCR is scheduled with a PDSCH including a MAC-CE for activating semi-static on-off signaling and transmits a PUCCH including corresponding HARQ-ACK, it may periodically repeat on-off operation after 3 ms from the last symbol of the PUCCH. The base station may perform the UE association identification process every period. The NCR may receive higher layer settings for semi-static on/off operation as follows.
Duration (16-01): the NCR may be configured with a slot-based duration for on or off. If not configured, the NCR may expect a default value.
Period (16-02): the NCR may be configured with a periodicity for on or off. The period may be calculated as the difference between the start slot of a specific interval and the start slot of the next interval. For example, 16-02 indicates that the period is n slots. The period may be in slot units or in time units (e.g., ms). If not configured, the NCR may expect a default value.
On off configuration: the NCR may be configured with states to be applied in the semi-static on/off operation. Specifically, it may be configured in one or a combination of the following methods.
   <Method 3-1> The NCR may not receive explicit settings for on or off states. In this case, the NCR may determine whether a slot is on or off with respect to the slot immediately preceding the first slot among slots of the duration. For example, the reference slot of the first interval 16-03 is slot 1, and if slot 1 is in the on state, 16-03 may be set to an off state, or if slot 1 is in the off state, 16-03 may be set to an on state. For the second interval 16-04, on or off slots may be determined with respect to slot n+1 in the same way.
   <Method 3-2> The NCR may be explicitly configured with on or off states. If a state is configured, it may be applied equally to every period.
   <Method 3-3> The NCR may be configured with an on/off pattern as a bitmap. The NCR may be configured with a pattern in symbol units or slot units. If the pattern is set in symbol units, the same symbol pattern may be repeated for the duration. If the pattern is set in slot units, the bitmap may be applied in correspondence to one duration. The on/off pattern may be applied equally to all periods. If not configured, the NCR does not expect an on/off pattern.
   <Method 3-4> The NCR may receive a TDD configuration for on/off settings. In this case, the NCR may receive an indication of downlink/uplink/flexible symbol (D/U/F) and ‘O’ (off) state. At this time, downlink/uplink/flexible symbol may be considered as being in the on state. For example, if the NCR receives an indication of DDOFU, the NCR may perform an operation of transmitting in the downlink, entering an off state, and then transmitting in the uplink. In this disclosure, ‘O’ refers to the off state for convenience of explanation. However, the disclosure is not limited to the terms described below, and other terms having equivalent technical meanings may be used. The NCR does not expect that the TDD configuration indicated by the above field changes the downlink or uplink symbol set via cell-specific or higher layer signaling to uplink or downlink. The NCR may expect an operation of changing configured D/F/U to ‘O’ or changing ‘O’ to D/F/U. If the NCR receives the above TDD configuration, this may include multiple TDD configurations and their combinations. If not configured, the NCR does not expect semi-static on/off signaling based on a TDD configuration.

If the NCR receives the above higher layer signaling, is scheduled with a PDSCH including a MAC-CE for on/off activation, and then transmits a PUCCH including corresponding HARQ-ACK, it may repeat periodically the on/off operation after 3 ms from the last symbol of the PUCCH. If the base station determines that the first stage of UE association identification is sufficient on its own, it may deactivate the semi-static on/off. In the same way, In the same way, if the NCR is scheduled with a PDSCH including a MAC-CE for on/off deactivation and then transmits a PUCCH including corresponding HARQ-ACK, it does not perform periodic repetition of on/off operation after 3 ms from the last symbol of the PUCCH.

Semi-static on-off signaling may have a higher priority than dynamic on-off signaling because it can support periodic UE association identification. For example, if semi-static on-off signaling sets an off state in a symbol or slot where dynamic on-off signaling has indicated an on state, the NCR may apply the off state.

The NCR may perform amplification and forwarding operations for signals and channels important to the system even in the off state. For example, SSB, type 0 PDCCH CSS search area, channel containing the SIB, and PRACH are cell-specific signals or channels that can be configured not only for the UE but also for the NCR, so the UE and the NCR may share the same configuration. If a cell-specific system-critical signal or channel (e.g., SSB, type 0 PDCCH CSS search area, channel containing SIB, PRACH) overlaps with off-state symbols by at least one symbol, the NCR may ignore the off state of the overlapping symbol and perform an operation in the on state.

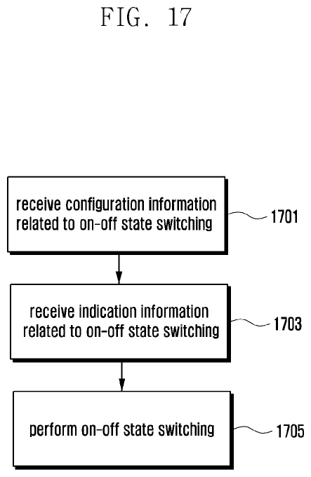

FIG. 17 is a flowchart illustrating an example of NCR operation according to an embodiment of the disclosure. The method of FIG. 17 is intended to be illustrative, and various modifications may be made to the method illustrated in the flowchart of FIG. 17. For example, steps listed in sequence in the diagram may overlap each other, occur in parallel, occur in different orders, or occur multiple times. In another example, one step may be omitted or be replaced with another step. With reference to FIG. 17, according to an embodiment, at operation 1701, the NCR may receive higher layer signaling including configuration information related to an on-off state transition of the NCR.

According to an embodiment, at operation 1703, the NCR may receive control information including indication information related to the on-off state transition.

According to an embodiment, at operation 1705, the NCR may make an on-off state transition based on the configuration information and the control information. For more specific details on the operation of the NCR illustrated in FIG. 17, refer to the description of the above-described embodiment.

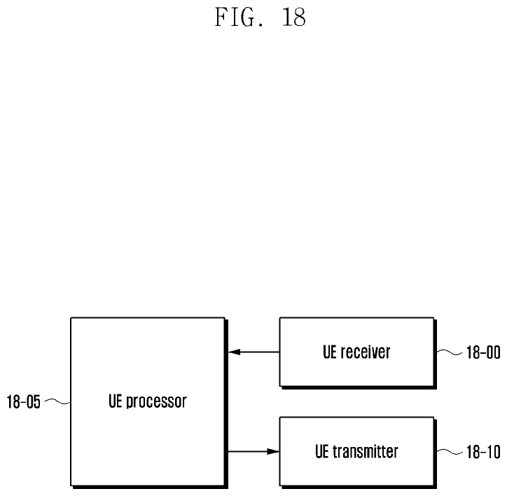

FIG. 18 is a block diagram illustrating the structure of a UE in a wireless communication system according to an embodiment of the disclosure.

With reference to FIG. 18, the UE may include a UE receiver 18-00, a UE transmitter 18-10, and a UE processor (controller) 18-05.

For example, as described above, the NCR that relays between the UE and the base station appears as a UE from the base station's perspective, so in this case, the UE in FIG. 18 may be an NCR. For example, the NCR may include a receiver, a transmitter, and a processor (controller).

The UE receiver 18-00 and the UE transmitter 18-10 may be collectively referred to as a transceiver. According to the communication methods of the UE described above, the UE receiver 18-00, the UE transmitter 18-10, and the UE processor 18-05 of the UE may operate. However, the components of the UE are not limited to those described above. For example, the UE may include more or fewer components (e.g., memory, etc.) than those components described above. Further, the UE receiver 18-00, UE transmitter 17-10, and UE processor 18-05 may be implemented in the form of a single chip.

The UE receiver 18-00 and UE transmitter 18-10 (or, transceiver) may transmit and receive signals to and from the base station. Here, the signal may include control information and data. To this end, the transceiver may be composed of an RF transmitter that up-converts the frequency of a signal to be transmitted and amplifies the signal, and an RF receiver that low-noise amplifies a received signal and down-converts the frequency thereof. However, this is only one embodiment of a transceiver, and the components of the transceiver are not limited to the RF transmitter and the RF receiver.

In addition, the transceiver may receive a signal through a radio channel and output it to the UE processor 18-05, and may transmit a signal output from the UE processor 18-05 through a radio channel.

The memory (not shown) may store programs and data necessary for the operation of the UE. Additionally, the memory may store control information or data included in a signal obtained by the UE. The memory may be composed of a storage medium such as ROM, RAM, hard disk, CD-ROM, and DVD or a combination of storage media.

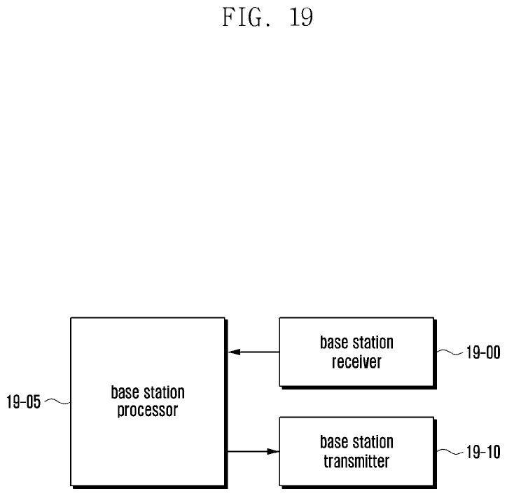

The UE processor 18-05 may control a series of processes so that the UE can operate according to the embodiments of the disclosure described above. The UE processor 18-05 may be implemented with a controller or one or more processors. FIG. 19 is a block diagram illustrating the structure of a base station in a wireless communication system according to an embodiment of the disclosure.

With reference to FIG. 19, the base station may include a base station receiver 19-00, a base station transmitter 19-10, and a base station processor (controller) 19-05.

For example, as described above, the NCR that relays between the UE and the base station appears to be a base station from the UE's perspective, so in this case, the base station in FIG. 19 may be an NCR. For example, the NCR may include a receiver, a transmitter, and a processor (controller).

The base station receiver 19-00 and the base station transmitter 19-10 may be collectively referred to as a transceiver. According to the communication methods of the base station described above, the base station receiver 19-00, the base station transmitter 19-10, and the base station processor 19-05 of the base station may operate. However, the components of the base station are not limited to those described above. For example, the base station may include more or fewer components (e.g., memory, etc.) than those components described above. Further, the base station receiver 19-00, the base station transmitter 19-10, and the base station processor 19-05 may be implemented in the form of a single chip.

The base station receiver 19-00 and base station transmitter 19-10 (or, transceiver) may transmit and receive signals to and from the UE. Here, the signal may include control information and data. To this end, the transceiver may be composed of an RF transmitter that up-converts the frequency of a signal to be transmitted and amplifies the signal, and an RF receiver that low-noise amplifies a received signal and down-converts the frequency thereof. However, this is only one embodiment of a transceiver, and the components of the transceiver are not limited to the RF transmitter and the RF receiver.

In addition, the transceiver may receive a signal through a radio channel and output it to the base station processor 19-05, and may transmit a signal output from the base station processor 19-05 through a radio channel.

The memory (not shown) may store programs and data necessary for the operation of the base station. Additionally, the memory may store control information or data included in a signal obtained by the base station. The memory may be composed of a storage medium such as ROM, RAM, hard disk, CD-ROM, and DVD, or a combination of storage media.

The base station processor 19-05 may control a series of processes so that the base station can operate according to the embodiments of the disclosure described above. The base station processor 19-05 may be implemented with a controller or one or more processors.

Meanwhile, the order of description in the drawings explaining the methods of the disclosure does not necessarily correspond to the order of execution, and the order of execution may be reversed or may proceed in parallel.

Alternatively, the drawings illustrating the methods of the disclosure may omit some components and include only some components without damaging the essence of the disclosure.

In addition, the method of the disclosure may be implemented by combining some or all of the contents included in individual embodiments within a range that does not damage the essence of the disclosure.

In addition, although not disclosed in the disclosure, a method of using a separate table or information including at least one component included in the table proposed in the disclosure is also possible.

Meanwhile, the embodiments of the disclosure disclosed in this specification and drawings are specific examples presented to easily explain the technical content of the disclosure and help understand the disclosure, and are not intended to limit the scope of the disclosure. That is, it will be apparent to those skilled in the art that other modifications based on the technical idea of the disclosure can also be carried out. Additionally, the above embodiments may be operated in combination as needed.

1. A method performed by a network-controlled repeater (NCR) including an NCR mobile termination (NCR-MT) and an NCR forwarding (NCR-Fwd)_in a communication system, the method comprising:
receiving, by the NCR-MT via higher layer signaling, a list of time resources for the NCR-Fwd;
receiving, by the NCR-MT via a physical downlink control channel (PDCCH), control information including at least one time resource indication of at least one time resource in the list of time resources; and
performing communication by the NCR-Fwd based on the at least one time resource after a slot offset from a particular slot,
wherein the slot offset is indicated by an offset configuration received by the NCR-MT via the higher layer signaling.

2-15. (canceled)

16. The method of claim 1, wherein the control information includes at least one indication where each of the at least one indication is associated with the NCR-Fwd being ON over a corresponding time resource in the at least one time resource.

17. The method of claim 1, wherein each time resource in the list of time resources corresponds to a number of symbols indicated by a duration configuration received by the NCR-MT via the higher layer signaling.

18. The method of claim 1, wherein the particular slot corresponds to a slot on which the PDCCH is mapped.

19. The method of claim 1, wherein the list of time resources is associated with a dynamic configuration operation for the NCR-Fwd, and the method comprises:
receiving, by the NCR-MT via higher layer signaling, sets of time resources associated with semi-static configuration operation for the NCR-Fwd and configurations where each of the configurations is associated with the NCR-Fwd being ON over a corresponding time resource in the sets of time resources;
receiving, by the NCR-MT via a physical downlink shared channel (PDSCH), a medium access control control element (MAC CE) of activation associated with a set of time resources of the sets of time resources;
transmitting, by the NCR-MT via a physical uplink control channel (PUCCH), hybrid automatic repeat request acknowledgement (HARQ-ACK) information associated with the PDSCH; and
performing communication by the NCR-Fwd based on the set of time resources after transmission of the HARQ-ACK information.

20. The method of claim 19, wherein the communication based on the set of time resources is performed after 3 ms from a slot on which the HARQ-ACK information is transmitted.

21. The method of claim 19, wherein each time resource of the sets of time resources corresponds to a duration indicated by a duration configuration received by the NCR-MT via the higher layer signaling, and
wherein each time resource of the sets of time resources is configured with a period indicated by a period configuration received by the NCR-MT via the higher layer signaling.

22. A network-controlled repeater (NCR) in a communication system, the NCR comprising:
an NCR mobile termination (NCR-MT) and an NCR forwarding (NCR-Fwd), wherein the NCR is configured to:
receive, by the NCR-MT via higher layer signaling, a list of time resources for the NCR-Fwd;
receive, by the NCR-MT via a physical downlink control channel (PDCCH), control information including at least one time resource indication of at least one time resource in the list of time resources; and
perform communication by the NCR-Fwd based on the at least one time resource after a slot offset from a particular slot,
wherein the slot offset is indicated by an offset configuration received by the NCR-MT via the higher layer signaling.

23. The NCR of claim 22, wherein the control information includes at least one indication where each of the at least one indication is associated with the NCR-Fwd being ON over a corresponding time resource in the at least one time resource.

24. The NCR of claim 22, wherein each time resource in the list of time resources corresponds to a number of symbols indicated by a duration configuration received by the NCR-MT via the higher layer signaling.

25. The NCR of claim 22, wherein the particular slot corresponds to a slot on which the PDCCH is mapped.

26. The NCR of claim 22, wherein the list of time resources is associated with a dynamic configuration operation for the NCR-Fwd, and the NCR is configured to:
receive, by the NCR-MT via higher layer signaling, sets of time resources associated with semi-static configuration operation for the NCR-Fwd and configurations where each of the configurations is associated with the NCR-Fwd being ON over a corresponding time resource in the sets of time resources;
receive, by the NCR-MT via a physical downlink shared channel (PDSCH), a medium access control control element (MAC CE) of activation associated with a set of time resources of the sets of time resources;
transmit, by the NCR-MT via a physical uplink control channel (PUCCH), hybrid automatic repeat request acknowledgement (HARQ-ACK) information associated with the PDSCH; and
perform communication by the NCR-Fwd based on the set of time resources after transmission of the HARQ-ACK information.

27. The NCR of claim 26, wherein the communication based on the set of time resources is performed after 3 ms from a slot on which the HARQ-ACK information is transmitted.

28. The NCR of claim 26, wherein each time resource of the sets of time resources corresponds to a duration indicated by a duration configuration received by the NCR-MT via the higher layer signaling, and
wherein each time resource of the sets of time resources is configured with a period indicated by a period configuration received by the NCR-MT via the higher layer signaling.
